(19) United States
(12) Patent Application Publication
(10) Pub. No.: US 2013/0294991 A1
(43) Pub. Date: Nov. 7, 2013

(54) Modified Oxide Supports For Enhanced Carbon Dioxide Adsorbents Incorporating Polymeric Amines

(71) Applicant: GEORGIA TECH RESEARCH CORPORATION, Atlanta, GA (US)

(72) Inventors: Christopher W. Jones, Mableton, GA (US); Yasutaka Kuwahara, Atlanta, GA (US)

(73) Assignee: Georgia Tech Research Corporation, Atlanta, GA (US)

(21) Appl. No.: 13/887,278

(22) Filed: May 3, 2013

Related U.S. Application Data
(60) Provisional application No. 61/642,219, filed on May 3, 2012.

(51) Int. Cl. B01J 20/26; B01D 53/62; B01J 20/32

(52) U.S. Cl. CPC B01J 20/261; B01J 20/327; B01D 53/62
USPC 423/228; 252/184

(57) ABSTRACT

A tunable species removal media including a polymer-impregnated porous material with the introduction of heteroatoms into the porous material during the synthesis of the oxide support. The polymer can be poly(ethyleneimine) (PEI), the porous material a framework of silica nanoparticles, and the heteroatoms selected from Zr, Ti, Fe, Ce, Al, B, Ga, Co, Ca, P, and Ni. The media has a CO₂ adsorption of greater than 0.19 mmol CO₂/g when exposed to a 400 ppm CO₂/Ar flow at a rate of 100 mL/min, and can also have a CO₂ adsorption of greater than 0.65 mmol CO₂/g when exposed to a 10% CO₂/Ar flow at a rate of 100 mL/min. The media can have a heteroatom/Si molar ratio greater than or equal to 0.002.

### CROSS-REFERENCE TO RELATED APPLICATIONS

This application claims the benefit of U.S. Provisional Application No. 61/642,219 filed 3 May 2012, the entire contents and substance of which are hereby incorporated by reference.

### STATEMENT REGARDING FEDERALLY SPONSORED RESEARCH OR DEVELOPMENT

N/A

### BACKGROUND OF THE INVENTION

1. Field of Invention

This invention relates generally to the use of species removal media for more efficient removal of an unwanted species from a process stream containing the unwanted species, and more specifically to a tunable species removal media comprising the introduction of heteroatoms in a silica matrix loaded with polymeric amines.

2. Background and Related Art

The increasing CO₂ concentration in the atmosphere has been regarded as a leading contributor to global climate change witnessed over the last century. Approximately forty percent of anthropogenic CO₂ emissions are attributed to burning fossil fuels (coal, natural gas, oil) for power generation, and the atmospheric CO₂ level is anticipated to increase over the current concentration of approximately 395 ppm in the near future as fossil fuels remain the major source utilized to meet global energy demand. To reduce carbon emissions, worldwide efforts have been devoted to development of new and advanced materials and technologies/processes suited for efficient carbon capture and storage (CCS) and for improving the energy utilization efficiency.

CO₂ capture from ambient air has been suggested as a means of lowering the atmospheric CO₂ level as a mode of combating climate change. However, others have argued that some (or all) processes suggested to allow for CO₂ capture from ambient air cannot compete with traditional post-combustion CO₂ capture approaches, from an economic perspective. While the economics of processes have hardly been studied and are still ill-defined, supported amine materials have been shown to be promising materials that effectively remove CO₂ from gases with CO₂ concentrations similar to ambient air, and initial economic assessments are promising.

Absorption by amine-based aqueous solution has been a benchmark process for the post-combustion capture of CO₂ from large stationary sources, such as flue gas (ca. 10% CO₂) generated from coal-fired power plants. However, operational problems such as an energy-intensive regeneration step, oxidative degradation of the aqueous amines, and the corrosion of process equipment motivate alternative approaches.

The ability of supported amines to remove CO₂ from the air has the potential to not only impact air capture for environmental purposes, but also to open doors for on-demand, on-site CO₂ generation for productive purpose, such as feeding greenhouses, algae installations for bio-fuel production, or other industries.

A significant focus has recently been directed towards solid materials that can capture CO₂ reversibly in repeated cycles. Among the array of available solid adsorbents, silica-supported amine materials (e.g., amine-impregnated porous silicas (class 1), amine-grafted silica materials (class 2), and materials prepared via in-situ polymerization of an amine-containing monomer on a silica support (class 3) etc.) have recently emerged as promising candidates for this use. The promise of these materials is associated with the following aspects:

(i) a large CO₂ adsorption capacity;

(ii) an ability to reversibly adsorb CO₂ even from humid gas streams at low temperature; and

(iii) the high tunability of the amine type and silicate structure, allowing for good control over adsorbent properties.

Adsorptive separation of CO₂ from ambient air (ca. 400 ppm CO₂, the so-called “air capture”) now represents one of the fastest growing application areas of these silica-supported amine materials. CO₂ capture from ambient air has been suggested as a means of lowering the global atmospheric CO₂ concentration as a mode of combating climate change. Air capture has a potential advantage over conventional CCS because it can, in principle, be installed anywhere and can capture CO₂ from all sources, including small ubiquitous sources such as cars and homes, if the technology is operated on a sufficiently large scale.

Such solid adsorption materials are generally formed by contacting a solid support material with an amine source to absorb amine molecules on the surface of the solid material. The amine molecules on the solid material surface are then subjected to a process stream containing the unwanted species (for example, CO₂) such that upon contact with the amine and the solid material, the unwanted species binds with the amine functional group of the amine molecule, reducing the potential for the interaction of the amine functional group with the solid surface and increasing amine sites available for unwanted species capture.

While the economics of processes have hardly been studied and scalable processes are still very early in their development, the collected work to date demonstrates that the silica-supported amine materials are promising materials that effectively remove CO₂ from gases with CO₂ concentrations similar to ambient air, and initial economic assessments of processes employing supported amine materials are believed to be promising.

The ability of silica-supported amines to remove CO₂ from the air has the potential to not only impact air capture for environmental purposes, but also to open doors for on-demand, on-site CO₂ generation for productive use, such as feeding greenhouses, creation of a C1 feedstock for chemical and polymer production, feeding enclosed algae installations for bio-fuel production, or other industries. A key objective in the design of silica-supported amine adsorbents is to increase working capacities and to improve adsorption/desorption kinetics and materials stability over multiple regeneration cycles to meet both the economic and technical requirements needed for use in flue gas, air capture, or other applications.

To date, the research in this area has been predominantly focused on altering the amount and the nature of the amine groups and tuning the porosity/morphology of the silicate support. Silica (SiO₂) is the support material that has been used in the overwhelming majority of preparations of composite amine-oxide adsorbents. Examples of the use of other oxides such as alumina (Al₂O₃), titania (TiO₂), or composite oxides such as aluminosilicates (composed of aluminum, silicon, and oxygen, plus countercations) or titanosilicates (some silica tetrahedra are replaced by titanium octahedra) are rare. However, the role of the surface properties of the oxide support in class 1 aminopolymer-oxide composite adsorbents has been largely overlooked. Thus, there is significant untapped opportunity to improve adsorption characteristics by manipulating the intrinsic properties of the support, such as the acidity or basicity.

To further improve the efficiency of the removal of an unwanted species with species removal media, the introduction of heteroatom sites onto aminopolymer-impregnated porous silica systems may also provide productive synergism at the interface between the aminopolymer and the solid surface, thus accordingly providing improved unwanted species adsorption performance. It is the intention of the present invention to provide such a beneficial media.

### BRIEF SUMMARY OF THE INVENTION

Briefly described, in a preferred form, the present invention comprises systems, methods, and media providing enhanced unwanted species uptake over conventional systems. The present invention improves upon the conventional prototypical (class 1) amine-based solid adsorbents, by presenting a tunable species removal media where the solid framework contains isolated heteroatoms.

The present invention preferably comprises a tunable species removal media comprising a polymer-impregnated porous material with the introduction of heteroatoms into the porous material during the synthesis of the oxide support. In a preferred embodiment, the polymer has a high amine density, the porous material is a mesoporous material, and the heteroatoms are metal atoms. In further preferred embodiments, the polymer is poly(ethyleneimine) (PEI), the porous material is a framework of silica nanoparticles with a hexagonal array of pores, and the heteroatoms are selected from the group consisting of atoms of Zr, Ti, Fe, Ce, Al, B, Ga, Co, Ca, P, and Ni.

The removal media can comprise a sorbent for CO₂ capture. In a sorbent for CO₂ capture having an amine efficiency of X mol CO₂ mol⁻¹N, defined as the number of moles of CO₂ captured per mole of active amines, the present invention comprises doping the sorbent with heteroatoms such that the amine efficiency is at least 110% X, where X is the amine efficiency of the sorbent made from undoped support. In a more preferred embodiment, the present invention has an amine efficiency of at least 210% X. In a more preferred embodiment, the present invention has an amine efficiency of at least 400% X.

The present invention can comprise a nanocomposite sorbent, and the nanocomposite sorbent can comprise silica nanoparticles and polyethyleneimine (PEI).

The heteroatoms of the present invention are preferably selected from the group consisting of atoms of Zr, Ti, Fe, Ce, Al, B, Ga, Co, Ca, P, and Ni. In a more preferred embodiment, the heteroatoms are atoms of Zr.

In another embodiment of the present invention, a sorbent for species capture comprises a porous material comprising Silica, a polymer, and heteroatoms, wherein the polymer is impregnated in the porous material, and wherein the heteroatom/Si molar ratio is greater than 0.038.

The polymer can be an amine-containing polymer. The porous material can be a mesoporous material. The heteroatoms can be metal atoms.

In another embodiment of the present invention, a sorbent for species capture comprises a framework of silica nanoparticles, an amine-containing polymer, and heteroatoms, wherein the sorbent has a CO₂ adsorption of greater than 0.19 mmol CO₂/g when exposed to a 400 ppm CO₂/Ar flow at a rate of 100 mL/min. The sorbent can also have a CO₂ adsorption of greater than 0.65 mmol CO₂/g when exposed to a 10% CO₂/Ar flow at a rate of 100 mL/min. The sorbent can have a heteroatom/Si molar ratio greater than or equal to 0.002.

In another embodiment of the present invention, a sorbent for species capture comprises a framework of silica nanoparticles, poly(ethyleneimine) (PEI), and heteroatoms selected from the group consisting of atoms of Zr, Ti, Fe, Ce, Al, B, Ga, Co, Ca, P, and Ni. The PEI can be a low molecular weight, branched PEI. The framework can be SBA-15.

In another embodiment, the present invention comprises a method of increasing species capture comprising doping silica supports with heteroatoms. In yet another embodiment, the present invention comprises a method of enhancing material stability during species adsorption/desorption cycles comprising doping silica supports with heteroatoms. The species can be CO₂, or other gases, for example H₂S, NO₂, SO₂, and NO. The invention can further comprise capturing CO₂ with the doped silica supports with heteroatoms from a stream containing CO₂ with concentrations ranging from 1 ppm to 25% by volume. The heteroatoms can be metal atoms, and the silica supports can include polymeric amines. The heteroatoms can be selected from the group consisting of atoms of Zr, Ti, Fe, Ce, Al, B, Ga, Co, Ca, P, and Ni. The polymeric amines can be selected from the group consisting of poly(ethylenimine), poly(propylenimine), poly(allylamine), poly(vinylamine), and tetraethylenepentamine.

In another exemplary embodiment, the present invention comprises a polymer-impregnated porous material containing heteroatoms, where the polymer is low molecular weight, branched PEI, the porous material is Santa Barbara Amorphous type material (SBA-15), and the heteroatoms are Zr species.

One of the notable characteristics of silicate materials is an ability to create tunable or multi-functional porous solids via the introduction of heteroatoms (e.g., Al, Ti, V, Cr, Fe, Zr, Ce etc.) into the silica matrix by direct or postsynthetic procedures, through which highly elaborated functional materials and catalytic systems can be designed. However, the effectiveness of heteroatom-containing silicates such as aluminosilicates or titanosilicates as support materials for CO₂ capture applications has been largely disregarded.

Yet, the present invention provides for the outstanding enhancement of CO₂ adsorption performance of prototypical class 1, silica-supported aminopolymer adsorbents by the incorporation of Zr species within the silica framework, whereby the unique surface properties of the support surface play a critical, previously unrecognized role in creating efficient adsorbents.

Additionally, the present invention comprises mesoporous silica SBA-15 materials containing several different heteroatoms, including Al, Ti, Zr, and Ce as supports for poly(ethyleneimine) (PEI) to create an array of class 1 adsorbents. CO₂ capacities and amine efficiencies were determined from adsorption experiments under both conditions simulating flue gas (10% CO₂ in Ar) and ambient air (400 ppm CO₂ in Ar). The associated material structures including local information of the incorporated heteroatoms are characterized by spectroscopic and sorption techniques, in detail, to elucidate the impact of heteroatom incorporation on the structural properties and the performance.

The surface properties of the support materials were studied by thermogravimetric analysis (TGA) and temperature programmed desorption using NH₃ and CO₂ (NH₃/CO₂-TPD), and molecular level insights into the CO₂ adsorption/desorption process was obtained by in situ Fourier transform infrared (FT-IR) spectroscopy measurements. In addition, the stability and regenerability of the resultant amine-oxide composite materials, which are important for practical CO₂ capture applications, are also investigated.

One of the advantageous characteristics of silicate materials is the ability to create tunable porous solids via the introduction of heteroatoms (e.g., Al, Ti, and Zr) into the silica matrix by direct or postsynthetic procedures. It is expected that electrophilic/nucleophilic sites created in this way can play a role in CO₂ adsorption by acting as CO₂ or amine activating sites.

For example, it has been reported that adenine-grafted Ti-SBA-15 can efficiently catalyze cycloaddition of CO₂ with epoxides owing to its improved acid-base properties, coupling the Lewis acidity of the titanium sites with the basicity of grafted amines. Further investigation showed that aminopropyl-grafted silica including Ti sites spatially isolated from amine sites gives a material where both sites (i.e., Brønsted base and Lewis acid, respectively) retain their ability to perform independent chemistry.

PEI preferably is used as the polymer in the present invention as it is an amine source because of its high amine density and accessible primary amine sites on chain ends. Zr atoms preferably are the heteroatom species as Zr substitution creates more effective amine-stabilizing sites on the silica surface compared to, for example, Ti or other common heteroatoms. Indeed, the substitution of Zr atoms in the silicate matrix allows for creation of composite organic-inorganic adsorbents with dramatically enhanced CO₂ adsorption performance (as a function of Zr loading) using mixed gas simulating both traditional flue gas capture and CO₂ removal from ultra-dilute gas streams, such as ambient air.

The incorporation of Zr species into mesoporous silica creates a support material for low molecular weight polymeric amines to afford composite adsorbents with dramatically enhanced CO₂ adsorption properties. Whereas most work on this class of adsorbent materials (class 1 materials) has focused on employing larger amounts of aminopolymer, different types of aminopolymer, or silica supports with altered porosities, the present invention utilizes the acid/base properties of the support, which play a critical, previously unrecognized role in creating more efficient adsorbents. The combination of adsorption experiments and detailed physicochemical characterization showed that these new adsorbents, having an optimal amount of Zr (Zr/Si˜0.07), offer significantly increased CO₂ adsorption capacities, improved desorption kinetics and enhanced thermal stability and regenerability compared to conventional PEI/SBA-15 materials.

The present invention demonstrates that CO₂ adsorption characteristics of prototypical poly(ethyleneimine)-silica composite adsorbents (class 1 materials) can be drastically enhanced by tuning the acid/base properties of the support via heteroatom incorporation into the silica matrix. More specifically, under feed gas conditions simulating both air capture and capture from flue gas (400 ppm CO₂ and 10% CO₂, respectively), PEI aminopolymers supported on heteroatom-containing silicates showed increased CO₂ adsorption performance, with the extent of enhancement depending on the heteroatom species and their concentrations in the supports. Of the adsorbents studied, the material made from Zr-SBA-15 with moderate level of Zr (Zr/Si≈0.07) and still retaining its ordered mesoporosity was found to be the best material, followed by those composed of Ce-SBA-15 and Ti-SBA-15.

From adsorption experiments, combined with detailed structural characterization, incorporated heteroatoms are found to create an amphoteric surface that stabilizes PEI (probably via acid-base interactions), enabling the PEI to have an increased number of productive amine adsorption sites. This allows for easy access of incoming CO₂ molecules to the amine sites, accordingly yielding significantly increased CO₂ adsorption capacities, improved CO₂ adsorption/desorption kinetics, and enhanced regenerabilities.

In addition, these materials can be easily prepared with only a few modifications of the standard synthetic protocol for the prototypical PEI/SBA-15 adsorbents and possess durabilities over multiple adsorption/desorption cycles under both dry and humid conditions. With these advantageous and feasible characteristics, the PEI supported on heteroatom-incorporated SBA-15 composite adsorbents investigated here are promising candidates for practical CO₂ capture applications, including direct air capture, and warrant further studies. Further improvements to CO₂ performance may be successful by changing the kinds and configurations of heteroatoms and/or aminopolymers in these class 1 adsorbents.

The above outlines the outstanding enhancement of CO₂ adsorption performance of prototypical class 1, silica-supported aminopolymer adsorbents by the incorporation of Zr species within the silica framework, whereby it is demonstrated that the unique surface properties of the support surface play a critical, previously unrecognized role in creating efficient adsorbents.

However, the mechanism (whether the enhancement is associated with a change in the number of adsorption sites or the creation of adsorption sites with different strengths etc.) still remains to be elucidated. An extensive exploration of a variety of heteroatoms that could prove effective for enhancing CO₂ adsorption properties may provide constructive insight into this issue.

To this end, mesoporous silica SBA-15 materials containing several different heteroatoms, including Zr, Ti, Fe, Ce, Al, B, Ga, Co, Ca, P, and Ni, were explored as supports for poly(ethyleneimine) (PEI) to create an array of class 1 adsorbents. CO₂ capacities and amine efficiencies were determined from adsorption experiments under both conditions simulating flue gas (10% CO₂ in Ar) and ambient air (400 ppm CO₂ in Ar). The associated material structures including local information of the incorporated heteroatoms are characterized by spectroscopic and sorption techniques, in detail, to elucidate the impact of heteroatom incorporation on the structural properties and the performance. The surface properties of the support materials were studied by thermogravimetric analysis (TGA) and temperature programmed desorption using NH₃ and CO₂ (NH₃/CO₂-TPD), and molecular level insights into the CO₂ adsorption/desorption process was obtained by in situ Fourier transform infrared (FT-IR) spectroscopy measurements. In addition, the stability and regenerability of the resultant amine-oxide composite materials, which are important for practical CO₂ capture applications, are also discussed.

These and other objects, features and advantages of the present invention will become more apparent upon reading the following specification in conjunction with the accompanying drawing figures.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIGS. 1A and 1B are graphs, (1A) Small-angle and (1A) wide-angle XRD patterns of (a) calcined SBA-15 and calcined Zr-SBA-15 with varied Zr/Si atomic ratios (Zr/Si=(b) 0.04, (c) 0.07, (d) 0.11, and (e) 0.14 in the final solid). Several diffraction planes associated with 2D hexagonal mesoporous structure (P6 mm) are indicated for calcined SBA-15.

FIGS. 2A and 2B are graphs illustrating Nitrogen adsorption-desorption isotherms of (a) SBA-15 and Zr-SBA-15 with varied Zr/Si atomic ratios (Zr/Si=(b) 0.04, (c) 0.07, (d) 0.11, and (e) 0.14 in the final solid) (5A) before and (5A) after 30 wt % PEI impregnation. Filled and empty symbols represent adsorption and desorption branches, respectively.

FIGS. 3A and 3B are graphs showing pore size distributions obtained from N₂ physisorption for SBA-15 and Zr-SBA-15 materials (3A) before and (3B) after 30 wt % PEI impregnation.

FIG. 4 are TEM images of (a) calcined SBA-15 and (b) calcined Zr7-SBA-15 ((4a-1) and (4b-1): side-view, (4a-2) and (4b-2): top-view).

FIGS. 5A and 5B are graphs, (5A) Zr K-edge XAFS spectra and (5B) Fourier transforms of k³-weighted Zr K-edge EXAFS data of (a) zirconium oxychloride (ZrOCl₂.8H₂O), Zr-SBA-15 with varied Zr/Si atomic ratios (Zr/Si=(b) 0.04, (c) 0.07, (d) 0.11, and (e) 0.14 in the final solid), and (f) bulk ZrO₂.

FIG. 6 is the FT-Raman spectra of (a) calcined SBA-15, calcined Zr-SBA-15 with varied Zr/Si atomic ratios (Zr/Si=(b) 0.04, (c) 0.07, (d) 0.11, and (e) 0.14 in the final solid), and (f) bulk ZrO₂ as a reference.

FIG. 7 is a graph of CO₂ adsorption capacity (filled symbols) and amine efficiency (open symbols) of 30 wt % PEI-impregnated Zr-SBA-15 materials as a function of Zr/Si molar ratio of the support. The reported values are pseudo-equilibrium capacities measured at 25° C. under dry conditions (adsorption time was fixed at 12 h).

FIG. 8 shows the CO₂ adsorption capacities plotted as a function of temperature for PEI/SBA-15, PEI/Zr7-SBA-15, and PEI/Zr14-SBA-15. PEI loadings were fixed to be approximately 30 wt. % and CO₂ capacities were reported under dry conditions using simulated flue gas (10% CO₂).

FIGS. 9A and 9B are (9A) Weight loss curves and (9B) their first derivatives of PEI/SBA-15 and PEI/Zr-SBA-15 adsorbents from combustion in a TGA.

FIGS. 10A and 10B are FT-IR spectra of (a) raw PEI, (b) PEI/SBA-15, and (c) PEI/Zr7-SBA-15. The samples were evacuated under high vacuum for 12 h at room temperature to remove physisorbed water prior to measurement.

FIGS. 11A and 11B illustrate the correlation between CO₂ adsorption capacity and surface density of (11A) acid or (11B) basic sites of bare Zr-SBA-15 materials: () 10% and (♦) 400 ppm CO₂ adsorption. The amounts of acid/basic sites were calculated as moles of adsorbed NH₃/CO₂ obtained from TPD measurements divided by the BET surface areas.

FIGS. 12A and 12B are temperature programmed desorption profiles using (12A) NH₃ and (12B) CO₂ as probe molecules: (a) calcined SBA-15 and calcined Zr-SBA-15 with different Zr contents (Zr/Si=(b) 0.04, (c) 0.07, (d) 0.11, and (e) 0.14 in the final solid).

FIGS. 13A and 13B include graphs of in situ FT-IR difference spectra of (13A) CO₂ adsorbed on PEI/SBA-15 and PEI/Zr7-SBA-15 with increasing CO₂ pressures and (13B) CO₂ desorbed from CO₂-saturated PEI/SBA-15 and PEI/Zr7-SBA-15 as a function of vacuum time.

FIG. 14 is a graph of the temperature-swing multi-cycle CO₂ adsorption-desorption testing of PEI/SBA-15 and PEI/Zr7-SBA-15. CO₂ capacity under dry conditions at 25° C. using simulated ambient air (400 ppm CO₂) and regeneration under Ar flow at 110° C.

FIGS. 15A and 15B are (15A) Fourier transforms of k³-weighted Ti K-edge EXAFS spectra of Ti-SBA-15 with varied Ti/Si atomic ratios together with titanium tetraisopropoxide (Ti(OⁱPr)₄) and bulk TiO₂; and (15B) Fourier transforms of k³-weighted Zr K-edge EXAFS spectra of Zr-SBA-15 with varied Zr/Si atomic ratios together with zirconium oxychloride (ZrOCl₂.8H₂O) and bulk ZrO₂.

FIGS. 16A and 16B are (16A) Low-angle and (16B) High-angle XRD patterns of (a) SBA-15, (b) Al_{5.0}-SBA-15, (c) Al_{9.4}-SBA-15, (d) Ce_{0.4}-SBA-15, and (e) Ce_{0.6}-SBA-15.

FIGS. 17A and 17B show Nitrogen adsorption-desorption isotherms of (a) SBA-15, (b) Al_{5.0}-SBA-15, (c) Al_{9.4}-SBA-15, (d) Ce_{0.4}-SBA-15, and (e) Ce_{0.6}-SBA-15: (17A) before and (17B) after 30 wt % PEI impregnation. Filled and empty symbols represent adsorption and desorption branches, respectively. The isotherms are vertically shifted in steps of 500 cm³/g.

FIG. 18 is Al NMR spectra of Al_{5.0}-SBA-15 and Al_{9.4}-SBA-15. The line at 0 ppm corresponds to octahedrally coordinated Al atoms and the line positioned at around 54-58 ppm corresponds to tetrahedrally coordinated Al atoms surrounded by 4 Si atoms. The line seen at 24 ppm can be associated with penta-coordinated Al atoms, showing that Al species are mostly isolated within the silica framework in both materials, but create aggregated AlOₓ species upon increasing the Al content.

FIGS. 19A-19E are TEM images (left: side-view, middle: top-view) and the corresponding pore size distributions calculated by the BdB-FHH method (black: calcined samples, grey: PEI-impregnated samples) of (19A) SBA-15, (19B) Al_{9.4}-SBA-15, (19C) Ti_{4.3}-SBA-15, (19D) Zr_{7.0}-SBA-15, and (19E) Ce_{0.6}-SBA-15.

FIGS. 20A and 20B are Nitrogen adsorption-desorption isotherms of (a) SBA-15 and Ti-SBA-15 with varied Ti/Si atomic ratios (Ti/Si=(b) 0.002, (c) 0.014, (d) 0.043, and (e) 0.080 in the final solid): (20A) before and (20B) after 30 wt % PEI impregnation. Filled and empty symbols represent adsorption and desorption branches, respectively. The isotherms are vertically shifted in steps of 500 cm³/g.

FIGS. 21A and 21B are (21A) Low-angle and (21B) High-angle XRD patterns of (a) calcined SBA-15 and calcined Ti-SBA-15 with varied Ti/Si atomic ratios (Ti/Si=(b) 0.002, (c) 0.014, (d) 0.043, and (e) 0.08 in the final solid). Several diffraction planes associated with 2D hexagonal mesoporous structure (P6 mm) are indicated for calcined SBA-15 in the left, and several diffraction planes associated with anatase TiO₂ crystal are indicated in the right.

FIGS. 22A and 22B are FT-Raman spectra of (22A) calcined Ti-SBA-15 and (22B) calcined Zr-SBA-15 with varied metal to Si atomic ratios, together with reference bulk oxides (anatase TiO₂, and tetragonal ZrO₂, respectively).

FIGS. 23A and 23B are CO₂ adsorption capacity (filled symbols) and amine efficiency (open symbols) of (23A) 30 wt % PEI-impregnated Zr-SBA-15 and (23B) 30 wt % PEI-impregnated Ti-SBA-15 as a function of Me/Si molar ratio of the bare support. The reported values are the pseudo-equilibrium capacities at 25° C. under dry conditions.

FIGS. 24A and 24B illustrate CO₂ adsorption rates (left) and normalized CO₂ adsorption rates (right) measured at 25° C. under (24A) 400 ppm CO₂ or (24B) 10% CO₂ in Ar at a flow rate of 100 mL/min in a TGA. Figures show that introduction of moderate amounts of zirconium (3.8-11.0 mol % per Si) results in a significant improvement of CO₂ capacity and improved adsorption rate under both dilute (simulated flue gas) and ultra-dilute (simulated ambient air) conditions.

FIGS. 25A and 25B illustrate CO₂ adsorption rates (left) and normalized CO₂ adsorption rates (right) measured at 25° C. under (25A) 400 ppm CO₂ or (25B) 10% CO₂ in Ar at a flow rate of 100 mL/min in a TGA. Figures show that introduction of moderate amounts of titanium (1.4-4.3 mol % per Si) results in a significant improvement of CO₂ capacity and improved adsorption rate under both dilute (simulated flue gas) and ultra-dilute (simulated ambient air) conditions.

FIGS. 26A and 26B are (26A) Weight loss curves and (26B) their first derivatives of the PEI supported various Me-SBA-15 supports from combustion in a TGA.

FIG. 27 is an FT-IR spectra of (a) raw PEI, (b) PEI/SBA-15, (c) PEI/Ti_{4.3}-SBA-15, and (d) PEI/Zr_{7.0}-SBA-15. The samples were evacuated under high vacuum (less than 10⁻⁶ mbar) for 12 h at room temperature to remove physisorbed water prior to measurement. The absorption bands seen at around 1667/cm are assignable to remaining carbamic acid species strongly chemisorbed on aggregated PEI aminopolymer. The intensity of this band decreases in the order of PEI/SBA-15>PEI/Ti_{4.3}-SBA-15>PEI/Zr_{7.0}-SBA-15, indicating higher chemical/conformational stability of PEI supported on the metal-incorporated SBA-15 supports.

FIGS. 28A and 28B show the correlation between CO₂ adsorption capacity at 400 ppm CO₂ adsorption and surface density of (28A) acid or (28B) base sites of bare support materials. The amounts of acid/basic sites were calculated as moles of adsorbed NH₃/CO₂ obtained from TPD measurements divided by the BET surface areas.

FIGS. 29A-29D are temperature programmed desorption profiles using (left) NH₃ and (right) CO₂ as probe molecules of (29A) Al-SBA-15, (29B) Ti-SBA-15, (29C) Zr-SBA-15, and (29D) Ce-SBA-15 materials.

FIG. 30 shows the correlation between pseudo-equilibrium CO₂ adsorption capacity and adsorption half-time at 400 ppm CO₂ adsorption at operating temperature of 25° C.

FIGS. 31A and 31B show in situ FT-IR difference spectra of (31A) CO₂ adsorbed on PEI/SBA-15, PEI/Ti_{4.3}-SBA-15, and PEI/Zr_{7.0}-SBA-15 with increasing CO₂ pressures and (31B) CO₂ desorbed from CO₂-saturated PEI/SBA-15, PEI/Ti_{4.3}-SBA-15, and PEI/Zr_{7.0}-SBA-15 as a function of vacuum time. Samples were preheated at 105° C. under vacuum (less than 10⁻⁶ mbar) for at least 12 h. Sample spectrum was collected at room temperature.

FIG. 32 presents in situ FT-IR difference spectra of CO₂ adsorbed on bare SBA-15, bare Ti_{4.3}-SBA-15, and bare Zr_{7.0}-SBA-15 with increasing CO₂ pressures (0-10 mbar). The samples were pretreated at 110° C. under high vacuum (less than 10⁻⁶ mbar) for overnight to remove physisorbed water prior to measurement. The peaks seen at around 1621 and 1450/cm are assignable to carbonate anion species (CO₃²⁻) physisorbed on the support.

FIG. 33 illustrates temperature-swing multicycle CO₂ adsorption-desorption testing of PEI/SBA-15, PEI/Ti_{4.3}-SBA-15, and PEI/Zr_{7.0}-SBA-15. CO₂ capacity under dry conditions at 25° C. using simulated ambient air (400 ppm CO₂ in Ar) and regeneration under Ar flow at 110° C. for 3 h.

FIGS. 34A and 34B are In situ FT-IR difference spectra of CO₂ adsorbed on (34A) calcined SBA-15 and (34B) calcined Zr7-SBA-15 with increasing CO₂ pressures (0-10 mbar). The samples were pretreated at 110° C. under high vacuum to remove physisorbed water prior to measurement.

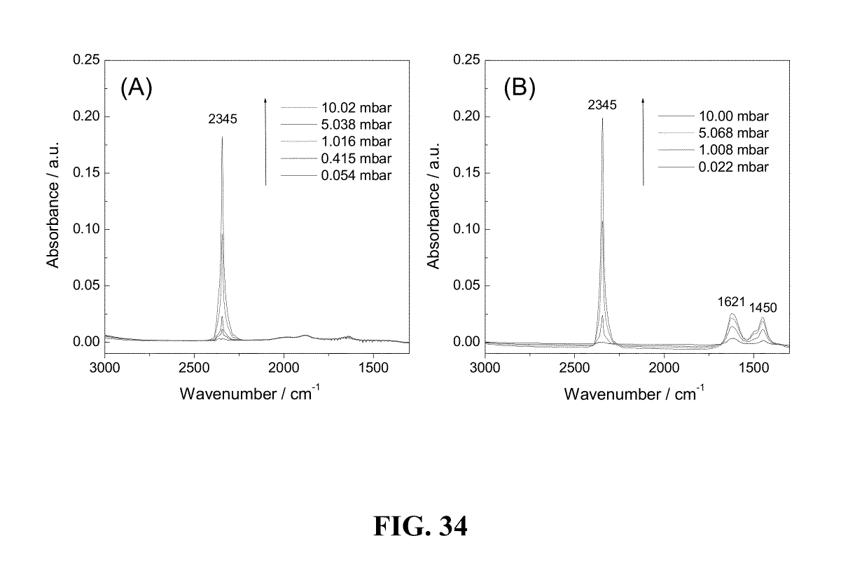

FIGS. 35A and 35B illustrate weight loss curves (left) and their first derivatives (right) of (35A) a series of PEI/Ti-SBA-15 adsorbents and (35B) a series of PEI/Zr-SBA-15 adsorbents from combustion in a TGA.

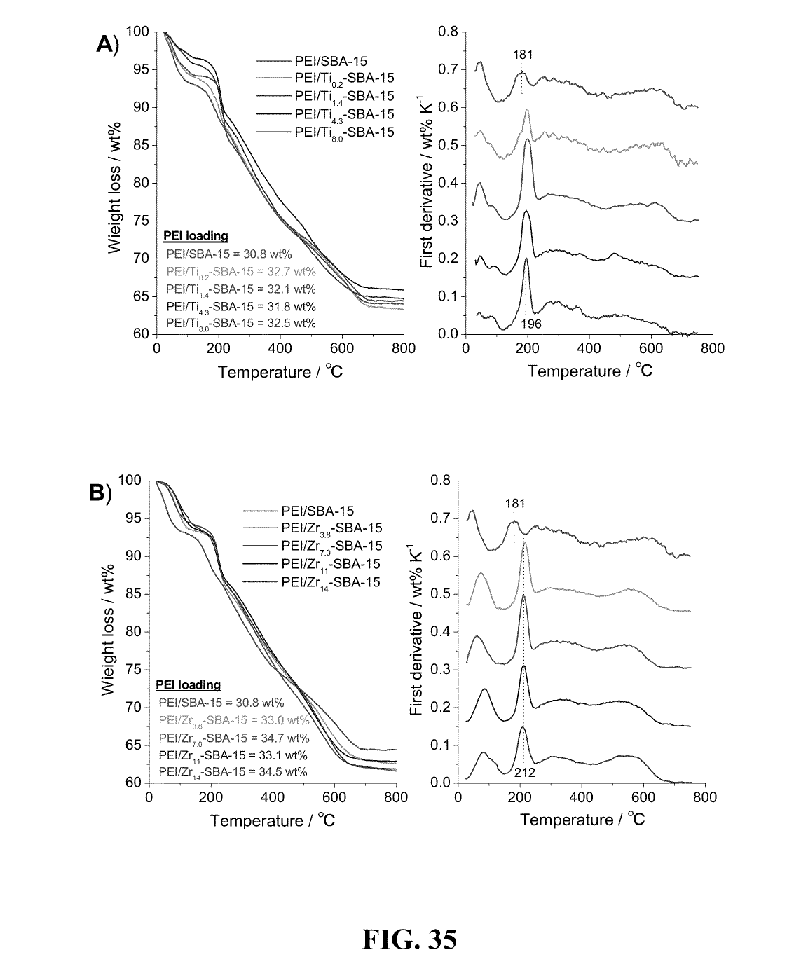

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

In a preferred embodiment, the present invention comprises a system of enhanced unwanted species uptake over conventional systems. In many of the following examples, the unwanted species is CO₂. The invention can comprise a polymer-impregnated porous material containing heteroatoms, where the polymer is low molecular weight, branched PEI, the porous material is Santa Barbara Amorphous type material (SBA-15), and the heteroatoms are Zr species.

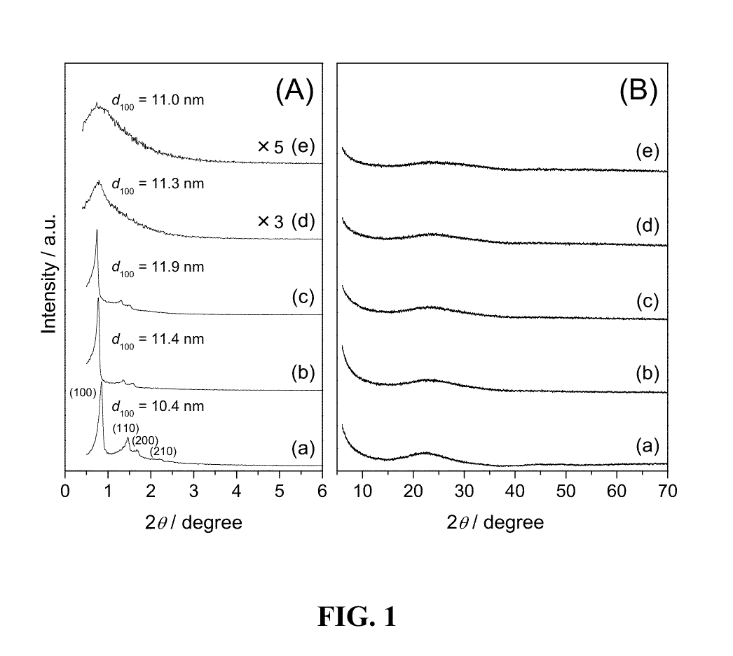

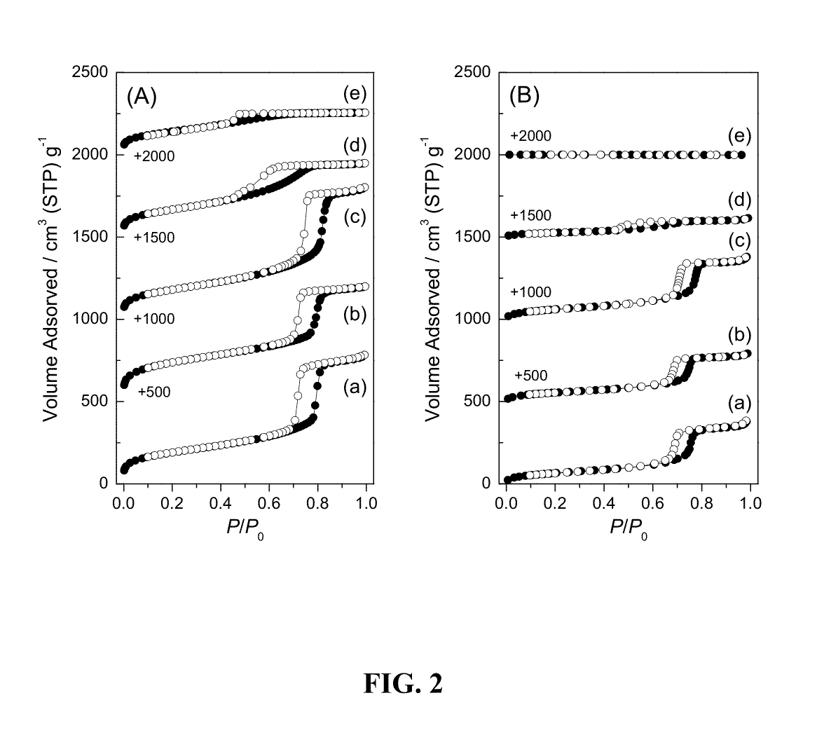

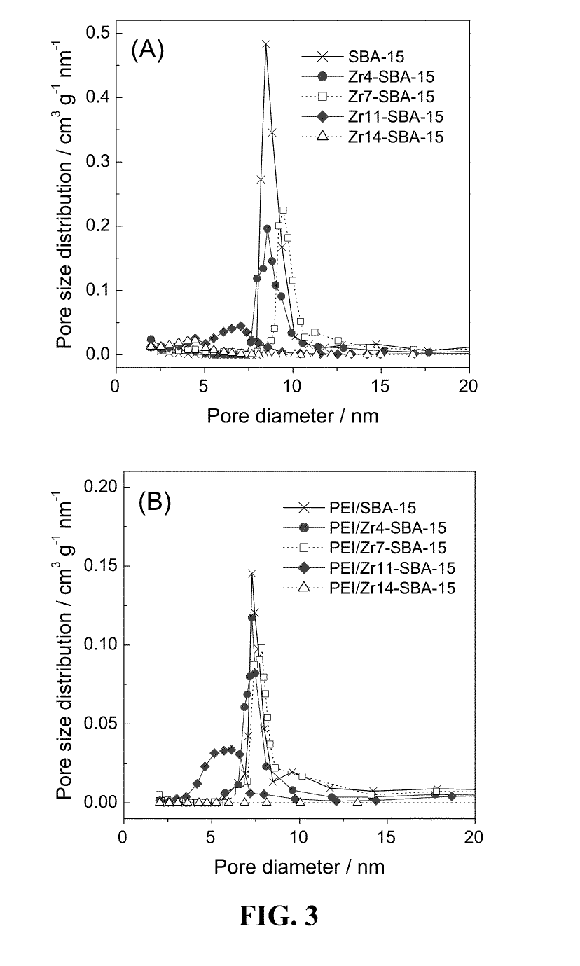

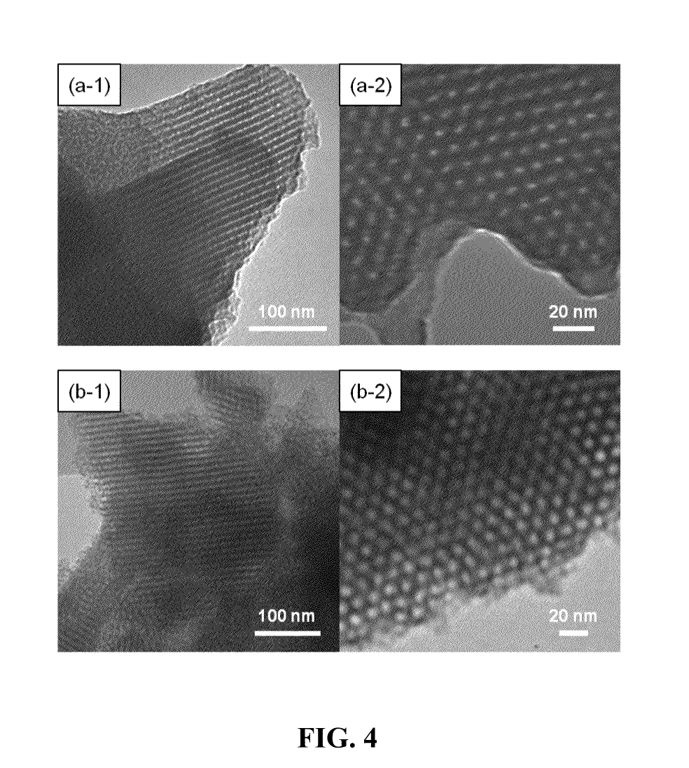

In a set of trials, structures of the obtained calcined Zr-SBA-15 materials with Zr/Si molar ratios ranging from 0.038 to 0.138 were characterized by means of X-ray diffraction (XRD), N₂ physisorption, and transmission electron microscopy (TEM), which identified the materials as having periodic 2D hexagonal mesoporous structures (P6 mm) with large surface areas (S_{BET}˜650 m²/g), large pore volumes (Vₚ˜1.2 cm³/g), and uniform pore sizes (dₚ˜9 nm) for the unmodified SBA-15, Zr4-SBA-15, and Zr7-SBA-15, as summarized in TABLE 1. See FIGS. 1-4.

TABLE 1
Textural Properties And CO₂ Adsorption Capacities Of PEI/Zr-SBA-15 Materials

| | | | | | | | | | | | | CO₂ adsorption^{g} | |
|---|---|---|---|---|---|---|---|---|---|---|---|---|---|
| | | | PEI | Amine | without PEI | | | with PEI | | | occupancy | 400 ppm | 10% |
| | Zr/Si^{a} | | loading^{b} | content | S_{BET}^{c} | Vₜₒₜₐₗ^{d} | Dₚ^{e} | S_{BET}^{c} | Vₜₒₜₐₗ^{d} | Dₚ^{e} | rate^{f} | (mmol | (mmol |
| Adsorbent | gel | product | (wt %) | (mmol N/g) | (m²/g) | (cm³/g) | (nm) | (m²/g) | (cm³/g) | (nm) | (%) | CO₂/g) | CO₂/g) |
| PEI/SBA-15 | — | — | 30.8 | 7.40 | 683 | 1.19 | 8.5 | 242 | 0.639 | 7.3 | 40 | 0.19 | 0.65 |
| PEI/Zr4-SBA-15 | 0.05 | 0.038 | 33.0 | 7.92 | 642 | 1.08 | 8.6 | 205 | 0.460 | 7.3 | 49 | 0.64 | 1.34 |
| PEI/Zr7-SBA-15 | 0.10 | 0.070 | 34.7 | 8.33 | 647 | 1.23 | 9.5 | 230 | 0.613 | 7.8 | 46 | 0.85 | 1.56 |
| PEI/Zr11-SBA-15 | 0.15 | 0.109 | 33.1 | 7.95 | 601 | 0.692 | 7.0 | 101 | 0.179 | 5.8 | 77 | 0.83 | 1.41 |
| PEI/Zr14-SBA-15 | 0.20 | 0.138 | 34.5 | 8.28 | 510 | 0.395 | 4.4 | <1.0 | <0.01 | N.D. | 143 | 0.26 | 0.24 |

^{a}Values were determined from elemental analysis.
^{b}Determined by TG analysis.
^{c}Calculated from the adsorption branch of the N₂ iso-therms by BET (Brunauer-Emmett-Teller) method.
^{d}Values at P/P₀ = 0.99
^{e}Estimated by the BdB-FHH (Frenkell-Halsey-Hill-modified Broekhoff-de Boer) method.
^{f}Defined by an equation of [Occupancy rate (%)] = [calculated aminopolymer volume (cm³-polymer/g-SiO₂)]/[Vₜₒₜₐₗ of bare adsorbent (cm³/g)] × 100 assuming the PEI density of 1.07 cm³/g.
^{g}Measured at 25° C. under dry conditions (adsorption time 12 h).
N.D.—Not determined.

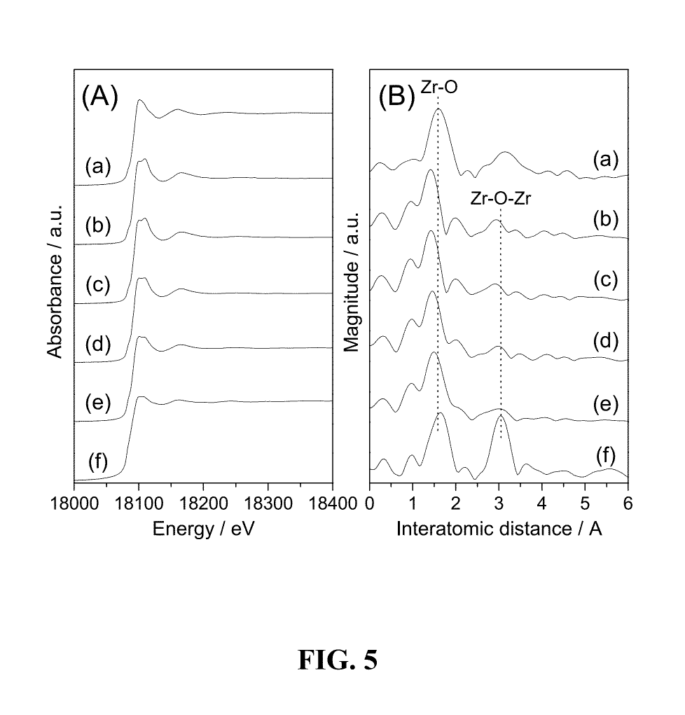

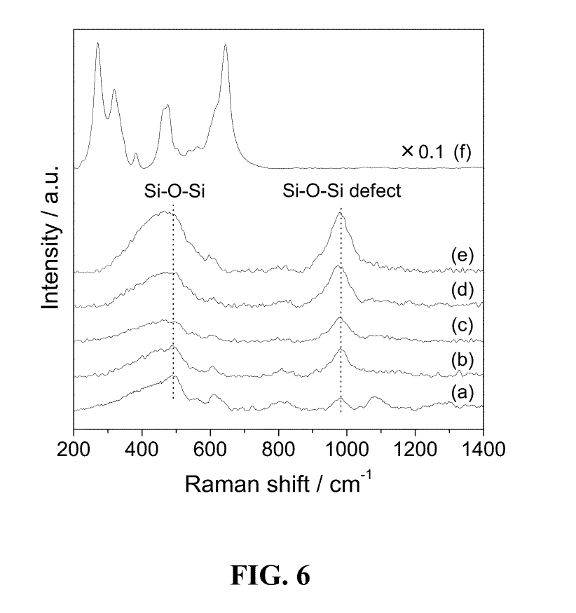

However, partial collapse of the mesostructure with appreciable loss of surface area and pore volume was observed when more than 15 mol % of Zr was used. Zr K-edge X-ray absorption fine structure (XAFS) coupled with XRD and FT-Raman spectroscopy confirmed that the Zr species are mostly present as highly dispersed and isolated sites within the silica framework in all cases, but causes a distortion of the silica network, being accompanied by creation of silica defect sites such as silanols, upon increasing the Zr content. FIGS. 5-6.

In addition, the effective charge of Zr was determined to be approximately 4+ in all cases based on the absorption edge energies of XAFS spectra. The energy shifts (ΔE₀ (eV)); corresponding to the difference between the threshold absorption energy values and that of ZrOCl₂.8H₂O) of Zr-SBA-15 samples were determined to be ΔE₀<±1.2 eV, indicating that the effective charge of Zr in the Zr-SBA-15 materials is approximately 4+ and the content of Zr³⁺ is quite small. Slight energy shifts towards lower energy positions upon increasing the Zr content seem to be reflecting the simultaneous creation of trace of oxygen defect sites and Zr³⁺ species, which is well consistent with the results obtained from Raman spectroscopy

These combined characterization results indicate that Zr atoms are effectively covalently-embedded within the silica matrix via isomorphous substitution, irrespective of the Zr content, but introduction of an excess of Zr (>15 mol %) leads to disordering of the mesostructure and results in reduced mesoporosity.

A series of PEI/Zr-SBA-15 composite materials was prepared by the physical impregnation of a low molecular weight PEI (MW=800) into the calcined Zr-SBA-15 samples using MeOH as solvent, in which the organic content was approximately adjusted to ca. 30 wt % for all samples. While larger adsorption capacities could undoubtedly be obtained using higher amine loadings (e.g., ca. 50 wt %), a more moderate loading was chosen here to promote close contact between the PEI polymers and the solid surface while still providing appreciable sample porosity.

Thermogravimetric analysis (TGA) confirmed the intended PEI loading levels in all cases, based on which amine loadings and occupancy rates were stoichiometrically calculated. As summarized in TABLE 1, PEI-impregnated SBA-15, Zr4-SBA-15, and Zr7-SBA-15 retained their ordered mesoporosity and sufficient pore volumes such that they could be considered porous adsorbents. In contrast, complete pore saturation was observed for PEI/Zr14-SBA-15 due to its smaller pore volume.

The CO₂ adsorption performance of the PEI/Zr-SBA-15 composites was analyzed by exposing the solids to a 10% or 400 ppm CO₂/Ar flow at a rate of 100 mL/min (both under dry conditions) in a TGA. The CO₂ uptake of the conventional PEI/SBA-15 was 0.19 and 0.65 mmol/g at 400 ppm and 10% CO₂ adsorption, respectively.

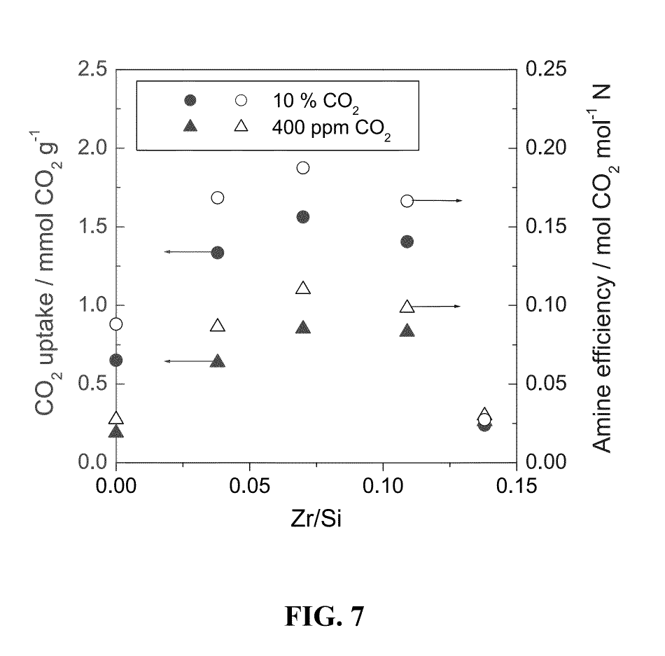

This sample provides the baseline performance to which the Zr substituted samples should be compared. The series of PEI/Zr-SBA-15 composite materials showed significantly increased CO₂ capacities and thus higher amine efficiencies under both dilute and ultra-dilute CO₂ conditions up to a Zr/Si ratio of 0.11, as shown in FIG. 7.

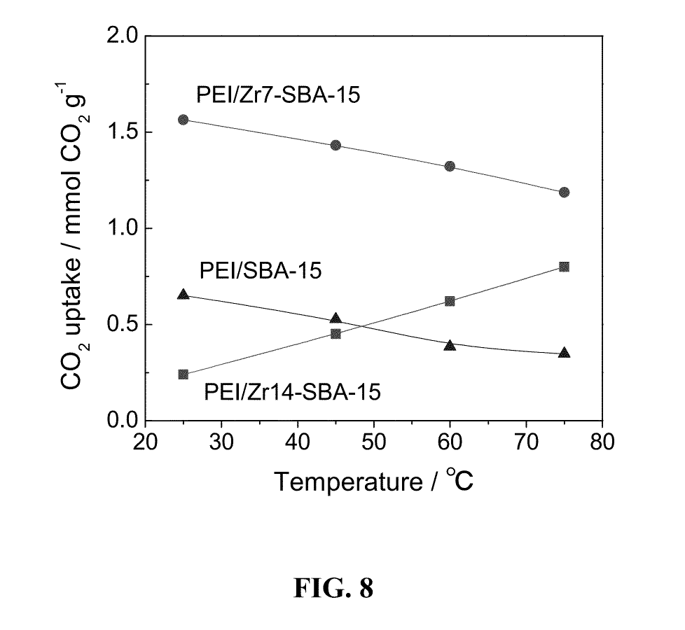

The highest CO₂ uptake was attained for PEI/Zr7-SBA-15, which showed amine efficiencies 2.1 times and 4.0 times higher than the conventional PEI/SBA-15 material under identical 10% and 400 ppm CO₂ adsorption conditions, respectively. Zr7-SBA-15 is shown to have the highest adsorption capacity over a range of temperatures, as well. FIG. 8. These results clearly demonstrate the material's outstanding CO₂ adsorption performance, especially from ultra-dilute gas.

It has been reported that at high PEI loadings (above 50 wt. % PEI, loadings that typically result in complete mesopore saturation with PEI), the CO₂ adsorption capacity increases with increasing adsorption temperature and the optimal temperature is at around 75° C. This has been explained to be due to restricted diffusion effects of CO₂ molecules diffusing through pores filled with dense PEI polymer. Although this trend is often associated with all PEI/silica composites, regardless of PEI-loading, others have shown that materials with PEI loadings that do not result in pore saturation have adsorption trends that track with thermodynamic expectations—reduced capacity upon increasing temperature (e.g. when 30 wt. % PEI-impregnated porous silica materials were used, a higher CO₂ uptake was achieved at 25° C. rather than at 75° C. Thus, one may hypothesize that the adsorption optimum around 75° C. may be associated with diffusion effects in PEI-filled mesopores.

In the present invention, substantial mesoporosity still exists for all materials after PEI impregnation, except PEI/Zr14-SBA-15. A higher CO₂ uptake was attained at 25° C. when PEI/SBA-15 and PEI/Zr7-SBA-15, both retaining high porosity (occupancy rates=40%, 46%, respectively, see TABLE 1) were evaluated over the range of 25-75° C.) were used as adsorbents. On the other hand, a higher CO₂ uptake was obtained at 75° C. over PEI/Zr14-SBA-15, whose pores are completely filled with dense PEI polymer (Occupancy rate=143%, TABLE 1). Furthermore, the PEI/Zr7-SBA-15, which still has significant residual porosity, showed higher CO₂ adsorption capacities over the whole range of temperature compared the other adsorbents, while following the same trend with temperature as other adsorbents with residual porosity, such as PEI/SBA-15. These results demonstrate that the enhancement associated with Zr sites in the silicate matrix is apparent at all adsorption temperatures.

Meanwhile, inclusion of excess Zr in the silica led to a reduced CO₂ uptake and decreased amine efficiency. This trend coincides with the changes in the support structure induced by excess Zr, as observed by structural analyses (vide supra). It is well-documented that the CO₂ capacity of these types of materials is strongly dependent on several structural factors, such as the pore diameter, remaining pore volume as well as the aminopolymer loading level. In this regard, the decreased performance of the PEI/Zr14-SBA-15 sample can be clearly associated with the poor structural characteristics of the support (e.g., surface area, porosity, etc.).

In contrast, the PEI loading, calculated occupancy rates, and structural parameters of the PEI/SBA-15, PEI/Zr4-SBA-15, and PEI/Zr7-SBA-15 adsorbents were all quite similar (see TABLE 1), yet the latter two materials presented significantly increased adsorption performance. This unambiguously demonstrates the positive effect of moderate levels of Zr incorporation in the silicate matrix on the CO₂ adsorption properties.

In contrast, others have found that Ti sites present on the silica support surface diminished the ability of the amines to adsorb CO₂ if the aminopropyl groups were directly grafted on its surface, since the Ti sites interacted with amines by acting as Lewis acid sites. This, coupled with the fact that the entire support surface is likely covered with aminopolymer in the present case, led to the hypothesis that strong, productive interactions between the PEI and Zr-containing oxide surface enhanced the ability of some of the amines to capture CO₂.

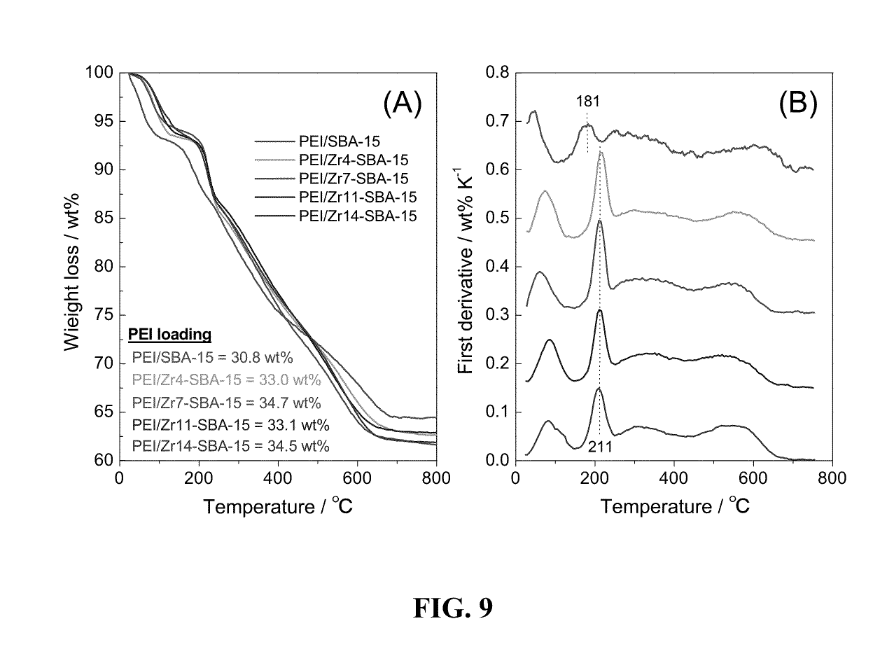

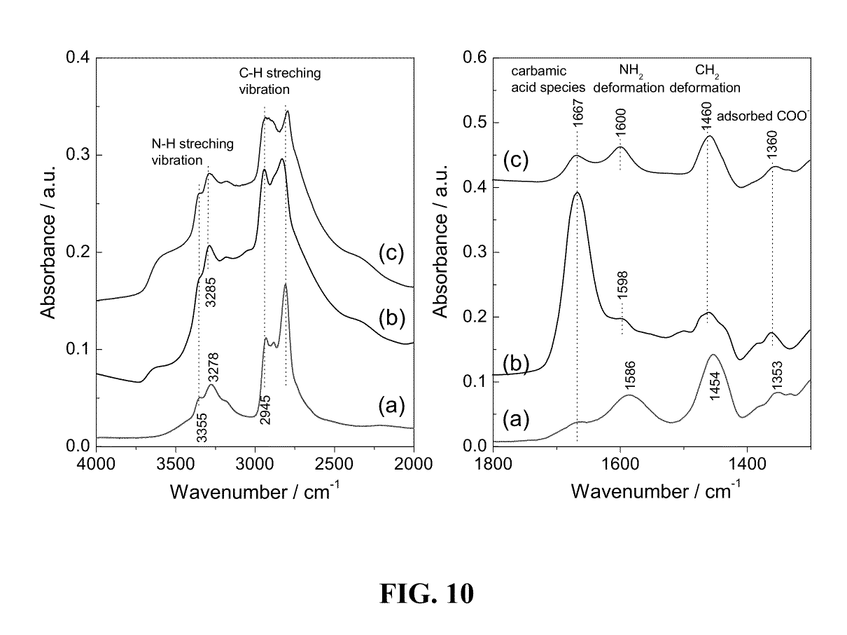

This hypothesis is supported by TGA and IR analyses. The PEI decomposition temperature determined from TGA shifted to 30° C. higher temperatures on the Zr-SBA-15 materials compared to traditional pure silica SBA-15. FIG. 9. A significant shift was also observed in FT-IR spectra, whereby several peak shifts assignable to NH₂ and CH₂ deformations of the PEI polymer were observed after impregnation onto the SBA-15 supports. Specifically, the former peak shift was more pronounced when Zr7-SBA-15 was used as the support. FIG. 10. These results suggest that the immobilized PEI interacts with Zr-SBA-15 surface differently than pure-silica SBA-15.

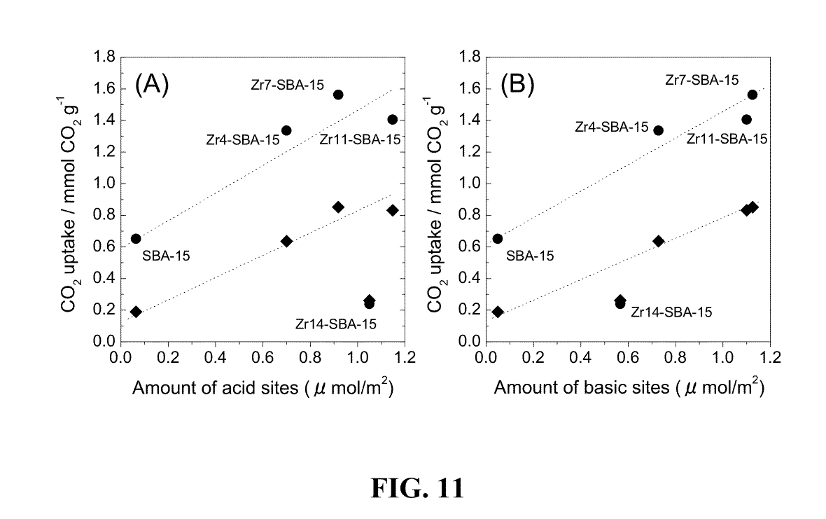

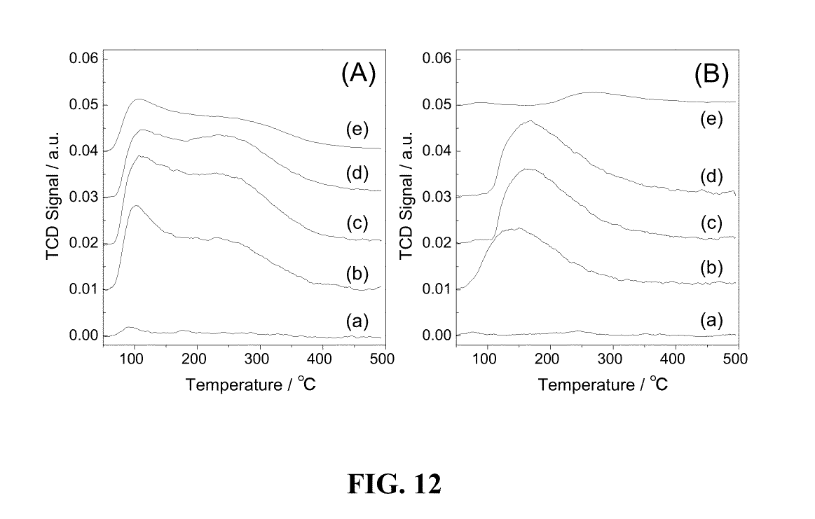

To quantitatively understand the effect of the incorporated Zr heteroatoms on the CO₂ adsorption, the measured CO₂ adsorption capacities of PEI/Zr-SBA-15 materials were plotted as a function of the surface density of the acid/base centers, FIG. 11, which were determined by NH₃/CO₂ TPD analysis, respectively (for TPD profiles, see FIG. 12). As the Zr content was increased from 0 to 0.11 mol %, both the surface acid and base densities increased in a roughly linear fashion, and distinct correlations between measured CO₂ capacities and the surface acid/base densities were observed under both adsorption conditions (10% and 400 ppm CO₂ in inert gas).

While Zr14-SBA-15 also possesses acid/base bifunctionality comparable to the other supports containing moderate amounts of Zr (Zr4-SBA-15 and Zr7-SBA-15), it deviated from these correlations due to its subpar porosity characteristics. At this stage, it is too early to unambiguously draw conclusions concerning the molecular level basis of the CO₂ adsorption capacity improvement upon moderate levels of Zr incorporation in the silicate framework, but a plausible explanation arises via stabilizing interactions between the aminopolymer and the amphoteric zirconosilicate support.

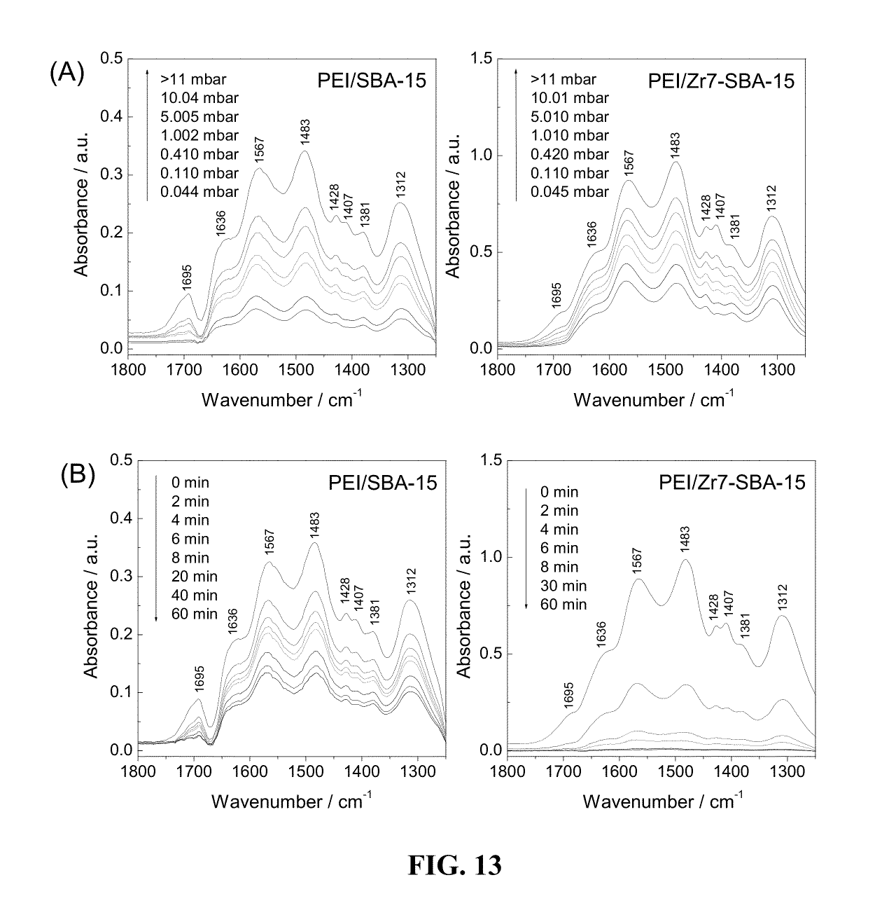

Based on the above hypotheses, in situ FT-IR experiments were undertaken to clarify the CO₂ adsorption kinetics on the adsorbents. As shown in FIG. 13A, in situ FT-IR difference spectra upon CO₂ adsorption show that PEI/Zr7-SBA-15, the adsorbent with the best CO₂ capacity among those examined, allowed for more efficient adsorption of CO₂ at low pressure with higher CO₂ capacity compared with the conventional PEI/SBA-15. Although the bare Zr7-SBA-15 was shown to have a trace CO₂ adsorption capacity, it accounts for only 1% of the total CO₂ capacity of PEI/Zr7-SBA-15, thereby ruling out the possibility of direct interaction between CO₂ and surface Zr sites driving the enhanced adsorption.

Regarding the CO₂ adsorption kinetics, the observed absorption bands are all typical of those previously reported on conventional amine-based adsorbents, indicating that the amine groups in PEI are the main adsorption sites for CO₂. The most noticeable differences observed via FT-IR were in the difference spectra upon CO₂ desorption. As shown in FIG. 13B, PEI/Zr7-SBA-15 allowed for rapid, nearly complete CO₂ desorption within short time period of applied vacuum (even at room temperature), compared to the traditional PEI/SBA-15 sorbent.

In the case of the conventional adsorbent, some fraction of the CO₂ adsorbed could not be eliminated even after a prolonged period of vacuum at room temperature, indicating limited adsorption reversibility of the PEI in silica, perhaps due to an aggregation/degradation of the PEI during the CO₂ adsorption. This is consistent with color changes of the adsorbent after multiple adsorption/desorption cycles. The PEI/SBA-15 changed from white to yellow after cycling, suggesting a substantial degradation/aggregation of the PEI, whereas PEI supported on Zr7-SBA-15 remained white even after repeated use. From the combined data, it was found that Zr atoms incorporated into the silicate stabilize the PEI, yielding enhanced adsorption capacities and limiting undesired degradation/aggregation of PEI.

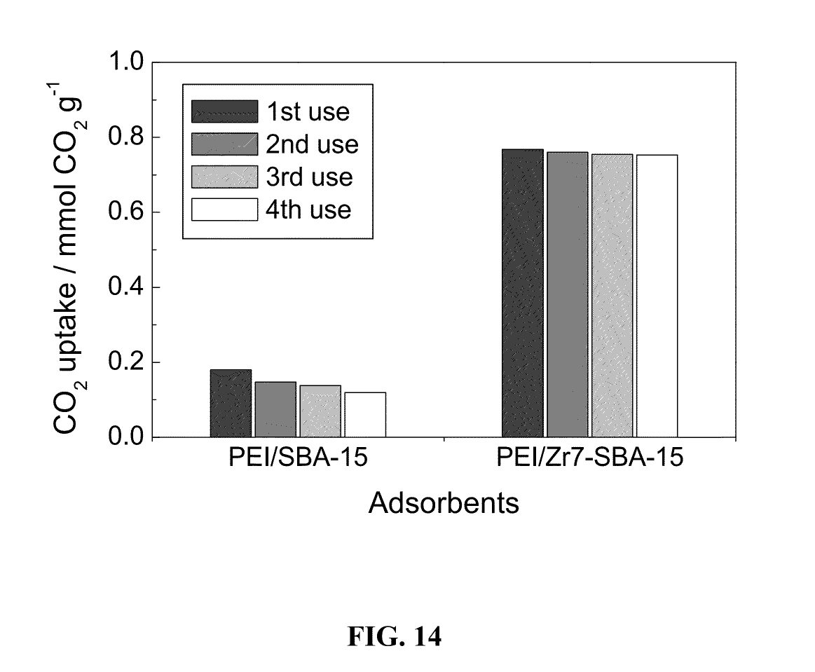

FIG. 14 compares CO₂ adsorption capacities of the conventional PEI/SBA-15 and PEI/Zr7-SBA-15 composites over four adsorption/desorption cycles at 25° C. with 400 ppm CO₂/Ar flow, in which the CO₂ was desorbed from the surface in a pure Ar atmosphere at 110° C. for 3 h. The CO₂ capacity of PEI/SBA-15 decreased significantly during moderate cycling; the adsorption capacity decreased by 34% after 4 cycles, showing that the conventional PEI/SBA-15 adsorbent has a limited stability under these bone dry conditions.

This continual capacity reduction may be associated with the loss of CO₂ adsorption sites, perhaps caused by amine degradation originating from urea formation, via amine loss, or by thermal conformational changes of the PEI during its repeated use. In contrast, the PEI/Zr7-SBA-15 composite, which was shown here to efficiently capture CO₂, adsorbed CO₂ reversibly in a temperature swing process while retaining most of its CO₂ capacity during the same number of cycles (decreased by 2% after 4 cycles), demonstrating promising regenerability. These results support the conclusion that Zr atoms on the silica surface efficiently stabilize PEI, providing thermal stability and adsorbent longevity.

Expanding beyond Zr, tunable or multi-functional porous solids via the introduction of heteroatoms beyond Zr (e.g., Al, Ti, V, Cr, Fe Ce etc.) into the silica matrix by direct or postsynthetic procedures, through which highly elaborated functional materials and catalytic systems can be designed. To this end, mesoporous silica SBA-15 materials containing several different heteroatoms, were explored as supports for poly(ethyleneimine) (PEI) to create an array of class 1 adsorbents.

TABLE 2
Textural Properties And CO₂ Adsorption Capacities of PEI Supported On Me-SBA-15
Materials (Me = Al, Ti, Zr, And Ce)

| | | | | | | | | | | | | CO₂ | |
|---|---|---|---|---|---|---|---|---|---|---|---|---|---|
| | | | | Amine | | | | | | | | adsorption^{[g]} | |
| | | | PEI | content | without PEI | | | with PEI | | | Occupancy | 400 ppm | 10% |
| | Me/Si^{[a]} | | loading^{[b]} | [mmol | S_{BET}^{[c]} | Vₜₒₜₐₗ^{[d]} | Dₚ^{[e]} | S_{BET}^{[c]} | Vₜₒₜₐₗ^{[d]} | Dₚ^{[e]} | rate^{[f]} | [mmol | [mmol |
| Adsorbent | gel | product | (wt %) | N/g] | [m²/g] | [cm³/g] | [nm] | [m²/g] | [cm³/g] | [nm] | [%] | CO₂/g] | CO₂/g] |
| PEI/SBA-15 | — | — | 30.8 | 7.40 | 683 | 1.19 | 8.5 | 242 | 0.639 | 7.3 | 40 | 0.19 | 0.65 |
| (Al-SBA-15) | | | | | | | | | | | | (0.20) | (0.66) |
| PEI/Al_{5.0}-SBA-15 | 0.18 | 0.050 | 34.4 | 8.26 | 661 | 1.28 | 9.5 | 255 | 0.649 | 7.5 | 44 | 0.29 | N.D. |
| | | | | | | | | | | | | (0.29) | |
| PEI/Al_{9.4}-SBA-15 | 0.25 | 0.094 | 33.1 | 7.95 | 628 | 1.19 | 9.3 | 268 | 0.743 | 8.0 | 45 | 0.22 | N.D. |
| (Ti-SBA-15) | | | | | | | | | | | | (0.23) | |
| PEI/Ti_{0.2}-SBA-15 | 0.01 | 0.002 | 32.7 | 7.85 | 740 | 1.26 | 9.2 | 250 | 0.690 | 7.7 | 41 | 0.32 | 0.97 |
| | | | | | | | | | | | | (0.33) | (0.98) |
| PEI/Ti_{1.4}-SBA-15 | 0.02 | 0.014 | 32.1 | 7.71 | 757 | 1.31 | 9.3 | 216 | 0.577 | 7.7 | 39 | 0.61 | 1.34 |
| | | | | | | | | | | | | (0.62) | (1.36) |
| PEI/Ti_{4.3}-SBA-15 | 0.05 | 0.043 | 31.8 | 7.64 | 758 | 1.41 | 10.7 | 209 | 0.664 | 8.8 | 35 | 0.64 | 1.27 |
| | | | | | | | | | | | | (0.65) | (1.28) |
| PEI/Ti_{8.0}-SBA-15 | 0.10 | 0.080 | 32.5 | 7.80 | 771 | 1.67 | 9.3 | 62.7 | 0.694 | N.D. | 31 | 0.50 | 0.87 |
| (Zr-SBA-15) | | | | | | | | | | | | (0.50) | (0.89) |
| PEI/Zr_{3.8}-SBA-15 | 0.05 | 0.038 | 33.0 | 7.92 | 642 | 1.08 | 8.6 | 205 | 0.460 | 7.3 | 49 | 0.64 | 1.34 |
| | | | | | | | | | | | | (0.64) | (1.35) |
| PEI/Zr_{7.0}-SBA-15 | 0.10 | 0.070 | 34.7 | 8.33 | 647 | 1.23 | 9.5 | 230 | 0.613 | 7.8 | 46 | 0.85 | 1.56 |
| | | | | | | | | | | | | (0.86) | (1.57) |
| PEI/Zr₁₁-SBA-15 | 0.15 | 0.109 | 33.1 | 7.95 | 601 | 0.692 | 7.0 | 101 | 0.179 | 5.8 | 77 | 0.83 | 1.41 |
| | | | | | | | | | | | | (0.85) | (1.43) |
| PEI/Zr₁₄-SBA-15 | 0.20 | 0.138 | 34.5 | 8.28 | 510 | 0.395 | 4.4 | <1.0 | <0.01 | N.D. | 143 | 0.26 | 0.24 |
| (Ce-SBA-15) | | | | | | | | | | | | (0.28) | (0.25) |
| PEI/Ce_{0.4}-SBA-15 | 0.05 | 0.004 | 32.7 | 7.85 | 786 | 1.32 | 9.0 | 225 | 0.634 | 8.0 | 40 | 0.68 | N.D. |
| | | | | | | | | | | | | (0.69) | |
| PEI/Ce_{0.6}-SBA-15 | 0.10 | 0.006 | 32.8 | 7.88 | 773 | 1.28 | 8.8 | 217 | 0.584 | 7.6 | 41 | 0.67 | N.D. |
| | | | | | | | | | | | | (0.68) | |

^{[a]}Values were determined from elemental analysis.
^{[b]}Determined by TG analysis.
^{[c]}Calculated from the adsorption branch of the N₂ isotherms by BET (Brunauer-Emmett-Teller) method.
^{[d]}Values at P/P₀ = 0.99
^{[e]}Estimated by the BdB-FHH (Frenkell-Halsey-Hill-modified Broekhoff-de Boer) method.
^{[f]}Defined by an equation of [Occupancy rate (%)] = [calculated aminopolymer volume (cm³-polymer/g-SiO₂)]/[Vₜₒₜₐₗ of bare adsorbent (cm³/g)] × 100 assuming the PEI density of 1.07 cm³/g.
^{[g]}Measured CO₂ adsorption capacities at 25° C. under dry conditions (adsorption time was fixed at 12
^{[h]}The values in parentheses are pseudo-equilibrium CO₂ adsorption capacities calculated by fitting the CO₂ adsorption curves with a pseudo-first-order adsorption model.
N.D.—Not determined.

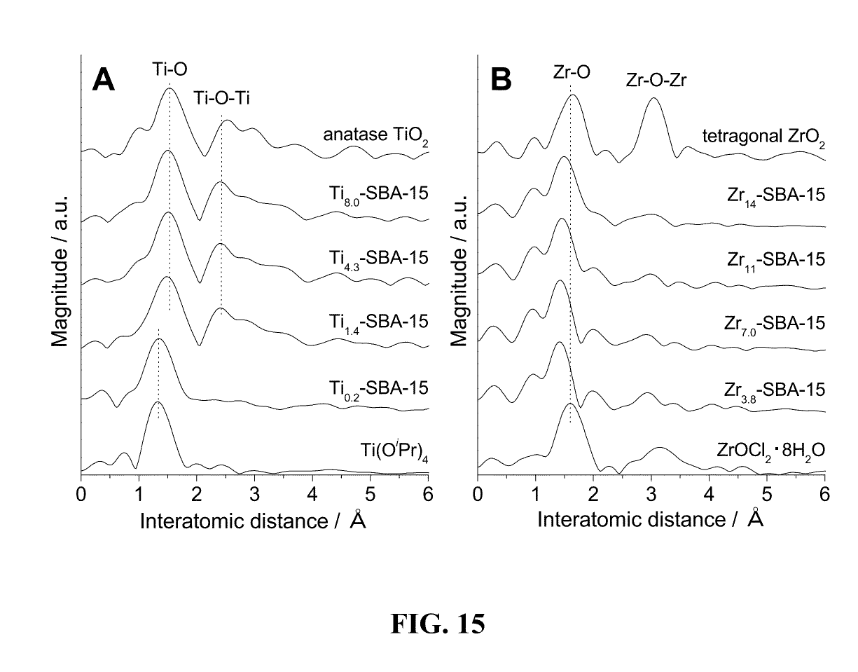

This characterization of the local environment of the Ti and Zr atoms in the SBA-15 samples are also corroborated by XAFS measurements. FIGS. 15A and 15B display the Fourier transforms of k³-weighted Ti K-edge extended XAFS (EXAFS) spectra of Ti-SBA-15 materials, as well as those of k³-weighted Zr K-edge EXAFS spectra of Zr-SBA-15 materials, along with spectra of reference samples. The first peaks seen at around 1.3-1.6 Å can be assigned to the backscattering due to the neighboring oxygen atoms, and a second shell at around 2.5-3.0 Å can be attributed to the contiguous Ti(Zr)—O—Ti(Zr) bonds.

The latter peak was scarcely observed for Ti_{0.2}-SBA-15 and all the Zr-SBA-15 materials, indicating that the Zr species (or Ti species in Ti_{0.2}-SBA-15) are mostly present as highly dispersed and isolated species in these samples. Contrary to these findings, distinct peaks were found in the second coordination shell for Ti-SBA-15 with more than 1.4 mol % of Ti content, reflecting the presence of agglomerated titanium oxide species. This result again well fits with the results of XRD and FT-Raman spectroscopy. In addition, a gradual increase in Zr—O interatomic distance was observed upon increasing the Zr content in Zr-SBA-15, implying the distortion of silica matrix by the insertion of Zr atoms with larger ionic radii. These combined characterization results demonstrate the incorporation of Zr atoms within the silica matrix via isomorphous substitution at all Zr levels examined in this study, but introduction of an excess amount of Zr (>15 mol %) leads a disordering of the mesostructure, and accordingly results in reduced mesoporosity.

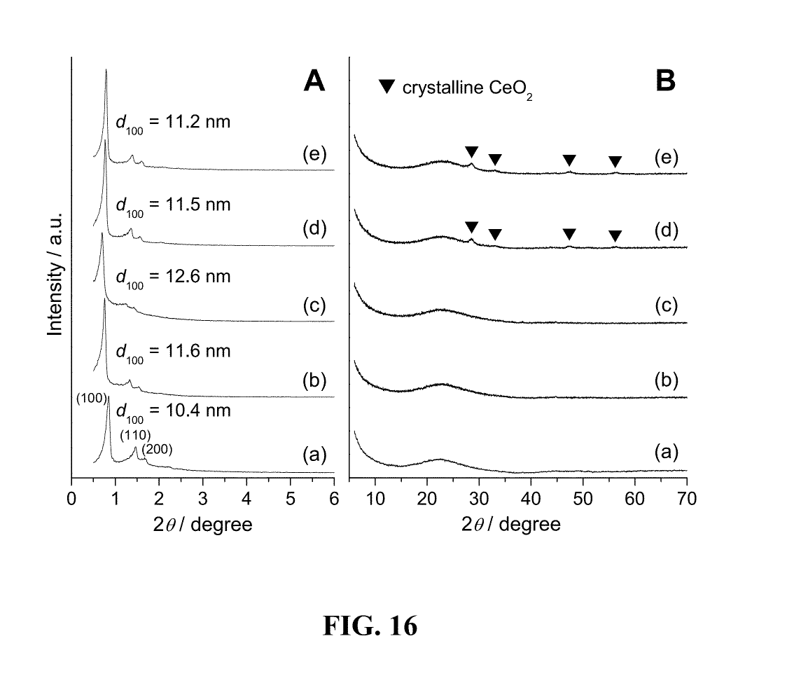

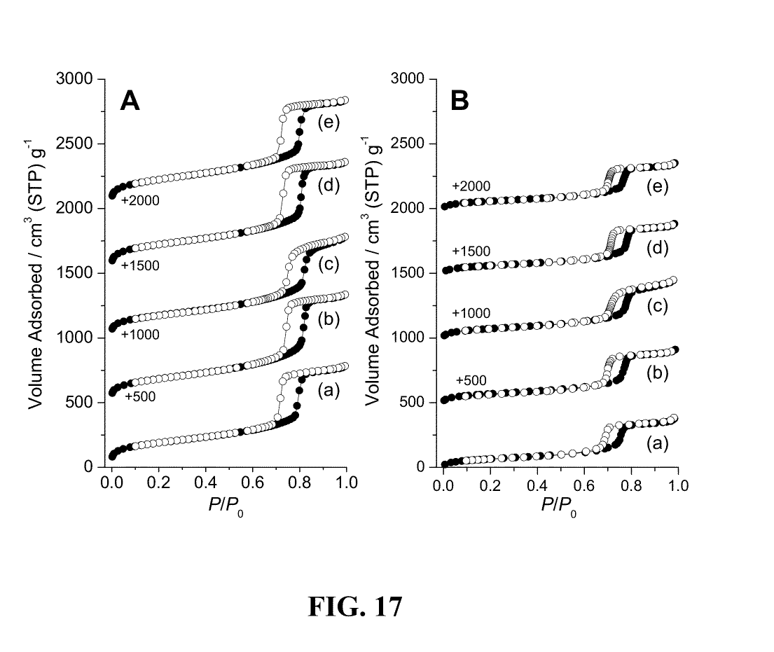

Al and Ce incorporation into SBA-15, in all cases, yielded materials that show clearly resolved diffraction patterns with high intensities in XRD (FIG. 16) and that possess pore parameters comparable to that of pure-silica SBA-15 (see TABLE 1. For N₂ physisorption isotherms, see FIG. 17).

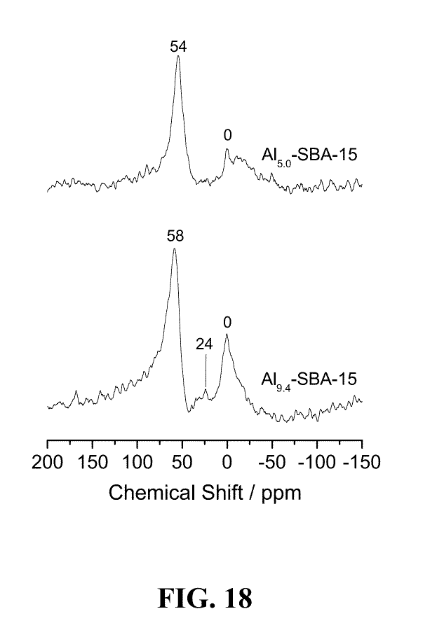

It should be noted that, for Al-SBA-15, an excess amount of Al precursor (more than twice as much as was incorporated) was added in the initial gels to achieve the incorporation of the desired amounts of Al into the silica matrix. For Ce-SBA-15, the incorporated amount of Ce was unfortunately significantly lower than expected (0.4-0.6 mol % Ce per Si). Thus, most of Al and Ce species added in the initial gel remained unincorporated into the silicate particles under the acidic synthesis conditions. Al MAS NMR analysis verified that the Al atoms are embedded within silica matrix mostly in tetrahedral coordination and, in part, in octahedral coordination (for Al MAS NMR spectra, see FIG. 18), suggesting the presence of isolated Al species and a small fraction of aggregated AlOₓ species. Similarly, the cerium species were shown to be present as dispersed CeO₂ nanocrystals in the silica matrix from XRD. These results indicate that neither Al nor Ce addition yielded any critical destruction of the SBA-15 porous structure within the compositional range examined in this study, despite the formation of polymeric aluminum/cerium oxide species. The presence or extent of structural damage and the resulting content of incorporated heteroatoms appear to be dependent on the kind and amount of the metal precursors used as well as synthetic conditions applied.

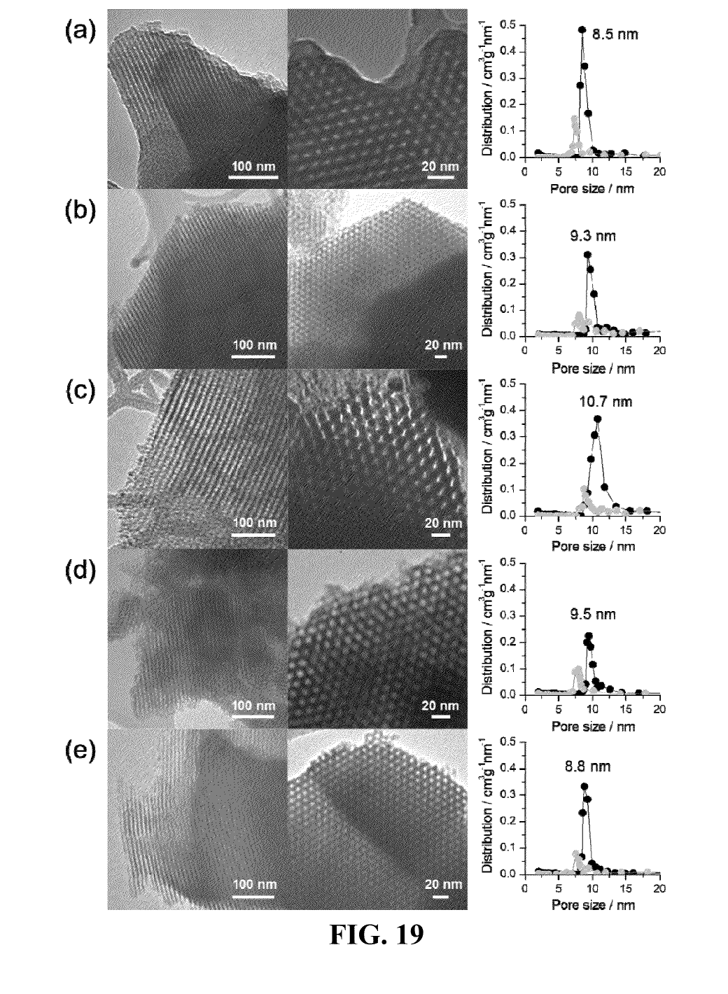

Structural ordering of the support materials was further confirmed by TEM. FIG. 19 shows side-view and top-view TEM images of some selected heteroatom-incorporated SBA-15 samples, together with the corresponding pore size distributions. The side-view TEM images (left side of FIG. 19) clearly show linearly aligned one dimensional pore channels arranged at regular intervals, whose average pore sizes fit well with those estimated from nitrogen adsorption isotherms by the BdB-FHH method. The top-view TEM images (middle of FIG. 19) also evidence the ordered hexagonal arrangements of the pores in all cases. These visual observations also reveal that the ordered porous structures are retained even after the heteroatom incorporation, leaving large pore volumes and uniform pore sizes (dₚ˜8.5-10.7 nm), sufficient for use as support materials for polymeric amines, unless a significant excess of heteroatoms (specifically, more than 10 mol % for Ti and more than 15 mol % for Zr) was added.

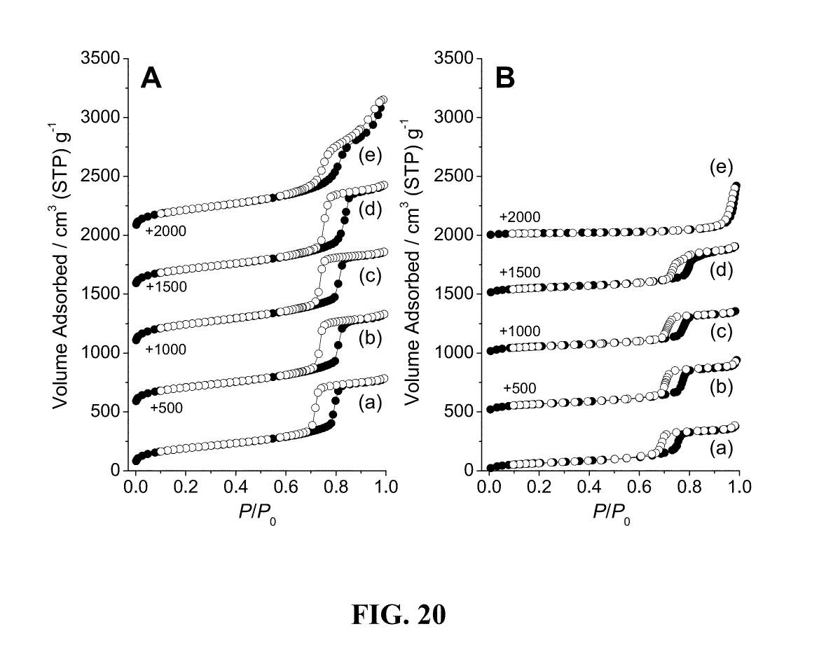

The thus synthesized and characterized Me-SBA-15 samples were used as supports for low-molecular weight, branched PEI (M_{w≈}800 Da) to prepare a series of PEI/Me-SBA-15 organic-inorganic composite adsorbents, whose organic content was approximately adjusted to ca. 30 wt % for all samples. It should be noted that the synthesized materials having average pore volumes of ca. 1.2 cm³/g could theoretically host up to 53 wt % of PEI within the pores, assuming a PEI density of 1.07 cm³/g. Of course, adsorbents with larger adsorption capacities could undoubtedly be obtained using higher amine loadings (e.g., ca. 50 wt %), however, a more moderate loading was chosen in this study to promote tight contact between the PEI polymers and the solid surface, as well as to compare all samples at a common amine content. As shown in TABLE 2, thermogravimetric analysis confirmed the intended PEI loading levels (30.8-34.7 wt %) in all cases, based on which amine contents and PEI occupancies were stoichiometrically calculated. As can be identified from the changes in nitrogen physisorption isotherms (FIG. 20B), the adsorbed nitrogen quantities appreciably decreased after the PEI impregnation (not only the case for Ti-SBA-15, but in all cases), suggesting that most of the PEI polymers were successfully sequestered into the mesopores, and not on the external surfaces. Because the hysteresis in the isotherm completely disappeared due to the filling of mesopores by PEI (FIG. 20B) (e)), the PEI loaded in this ill-defined porous silicate, Ti_{8.0}-SBA-15, is likely to yield a non-porous solid.

The pore characteristics calculated from the nitrogen adsorption-desorption isotherms provide direct information on the porosity of the PEI-impregnated samples. As summarized in TABLE 2, the pore parameters decreased substantially after the impregnation of 30 wt % PEI; however, most of the composites, except for PEI/Ti_{8.0}-SBA-15, PEI/Zr₁₁-SBA-15, and PEI/Zr₁₄-SBA-15, retained considerable surface areas (S_{BET}˜200-270 m²/g) and pore volumes (Vₚ˜0.46-0.74 cm³/g), which should be sufficient for effective mass diffusion of adsorbing and desorbing CO₂ gases. These composite materials commonly showed 1-2 nm reduced pore size distributions upon PEI impregnation (FIG. 19), hence they could still be considered as porous adsorbents.

In these materials, considering the occupancy rate of PEI to be around 35-49% of the total porosity and the fact that the adsorption-desorption branches were essentially parallel and still exhibited a narrow hysteresis, most aminopolymers are likely well-dispersed inside the pores without significant pore blocking, and the entire support surface is likely covered with aminopolymer, leaving little or no bare silicate surface exposed. On the contrary, the PEI loaded on ill-defined porous silicates such as Ti_{8.0}-SBA-15 and Zr₁₁-SBA-15 showed markedly reduced surface areas after PEI-impregnation due to the filling of their subpar mesoporosity by PEI. Specifically, complete pore saturation was observed for PEI/Zr₁₄-SBA-15. Such an overloaded sample is expected to behave less efficiently as an adsorbent because of the low accessibility of CO₂ molecules to the interior amine sites and its physically sticky/tacky nature, as discussed below.

### EXPERIMENTS/RESULTS/DISCUSSION

### Heteroatoms are Zr Species

### Materials

Pluronic P123 block copolymer (PEO₂₀-PPO₇₀-PEO₂₀), zirconium oxychloride (ZrOCl₂.8H₂O, purity >99%), methanol (reagent grade) and low-molecular weight poly(ethyleneimine) (PEI, Mw≈800) were purchased from Sigma-Aldrich. All other chemicals used for material synthesis were also purchased from Sigma-Aldrich and used without further purification. Single-component gases were purchased from Airgas, Inc. Custom gas mixtures (10% and 400 ppm CO₂ in Ar) were purchased from Matheson Tri-Gas, Inc.

### Synthesis

Zr-SBA-15 Synthesis: Zr-SBA-15 supports were synthesized similar to previously reported methods with minor modifications. In a typical synthesis, 3.0 g of Pluronic P123 as a pore directing agent, 1.77 g of NaCl, and 120 g of H₂O were stirred for 2 h in a 300 mL flask. To this micellular solution, an amount of zirconium oxychloride as a zirconium source and 6.44 g of tetraethylorthosilicate (TEOS) as a silicon source were sequentially added and stirred at 40° C. for 1 day. The molar ratio of the initial gel was adjusted to P123:Si:Zr:NaCl:H₂O=0.017:1.0:(0-0.2):1.0:220. The solution was transferred to an oven and then hydrothermally reacted at 100° C. for another day under static conditions. The resulting product was filtered, washed with deionized water, and dried overnight at 75° C. The as-synthesized Zr-SBA-15 samples were finally calcined at 500° C. for 10 h at a ramping rate of 3° C./min to remove the organic template. The synthesized samples were named as ZrX-SBA-15, where X is the atomic ratio of Zr/Si in the final product.

Impregnation of PEI:

The PEI-impregnated adsorbents were prepared by a conventional wet impregnation method. Specifically, the silica support previously dried at 75° C. overnight was immersed into a mixed solution containing the desired amounts of PEI and methanol, and then stirred at room temperature for 1 day. The weight ratios of this slurry were PEI/methanol/silica=0.43:10.0:1.0. This slurry was then placed in a rotary evaporator, and the methanol was removed under vacuum to facilitate the incorporation of the aminopolymer into the silica support. The resulting solid product was collected and stored in an oven at 75° C. until further characterization.

### Characterization

Powder X-ray diffraction (XRD) patterns were recorded on an MO3X-HF (Bruker AXS) diffractometer with CuKα radiation (λ=1.54056 Å). Nitrogen adsorption-desorption isotherms were measured at −196° C. using Micromeritics TriStar II 3020. The calcined samples were degassed at 200° C. under vacuum for 12 h prior to the measurements, while the PEI-impregnated samples were degassed at 100° C. for at least 12 h to vaporize the physisorbed water. The specific surface area was calculated by the BET (Brunauer-Emmett-Teller) method using adsorption data ranging from P/P₀=0.05 to 0.30. The pore size distributions were obtained from the adsorption branch of the N₂ isotherms by the BdB-FHH (Frenkell-Halsey-Hill-modified Broekhoff-de Boer) method. Transmission electron microscopy (TEM) images were obtained with a JEOL JEM100CX2 electron microscope. Elemental analysis was performed by Columbia Analytical Services. Amine loadings were determined by thermogravimetric analysis (TGA) using Netzsch STA409 instrument, in which the samples (ca. 20 mg) were subjected to continuous heating from room temperature to 900° C. at a heating rate of 10° C./min in an air flow (diluted with nitrogen) of 60 mL/min using α-Al₂O₃ as a standard.

Investigation of the local structure of Zr atoms in Zr-SBA-15 materials was performed by FT-Raman spectroscopy and XAFS (X-ray Absorption Fine Structure) measurement. FT-Raman spectroscopy was obtained on a Bruker Vertex 80v optical bench with a RAMII Raman module in the spectral range 200-1400/cm and with the spatial resolution of 4/cm. Zr K-edge XAFS spectra were recorded in the fluorescence mode at room temperature using the beam line BL01B1 at SPring-8, Hyogo, Japan. A Si(311) double crystal was used to monochromatize the X-rays from the 8 GeV electron storage ring. EXAFS data were examined using an EXAFS analysis program, Rigaku EXAFS. Fourier transformation of k³-weighted normalized EXAFS data (FT-EXAFS) was performed over the range 1.0<k/Å⁻¹<11.0 to obtain the radial structure function.

The acidity and basicity of the materials were studied by temperature programmed desorption using NH₃ and CO₂ as probe molecules (NH₃/CO₂-TPD), respectively, using Micromeritics AutoChem II 2920 Chemisorption Analyzer. Approximately 100 mg of samples was preheated at 500° C. for 1 h under a He flow (10 mL/min), and subsequently were allowed to cool to 50° C., where it was exposed to flowing NH₃ (2000 ppm in N₂) or CO₂ (bone dry CO₂) with a flow rate of 30 mL/min for 1 h. Then, the system was purged at 50° C. for 30 min with He to remove weakly adsorbed NH₃ or CO₂ molecules. The NH₃/CO₂-TPD was carried out between 50 and 500° C. under a He flow (10 mL/min) with a ramp rate of 10° C./min, and the desorbed NH₃/CO₂ was detected by a thermal conductivity detector.

Fourier transform infrared (FT-IR) spectroscopy was performed by using a Thermo Scientific 8700 FT-IR instrument with a MCT/A detector. Spectra were typically collected with 64 scans at a resolution of 4/cm. For in situ FT-IR spectroscopy of CO₂ adsorption/desorption, each sample was pressed into a self-supported wafer prior to analysis. The wafer was placed into a temperature controlled sample holder, which was loaded into a custom built, high-vacuum transmission FT-IR cell. Vacuum (less than 10⁻⁶ mbar) was applied to the wafer before it was heated to 105° C. for a duration of at least 12 h. After cooling to room temperature, the “activated” sample spectrum was collected. The background used for all samples was that of the empty transmission cell under high-vacuum and at room temperature. FT-IR difference spectra of CO₂ adsorbed on the samples were obtained with increasing CO₂ pressures from 0 to 11 mbar by subtracting the “activated” sample spectrum from the CO₂ dosed spectrum. FT-IR difference spectra of CO₂ desorbed from CO₂-saturated samples were collected every 60 s during evacuation under high vacuum at room temperature for 1 h, and utilized the aforementioned spectral subtraction procedure. After the experiment, the wafer was removed from the cell, and a circle with an exact diameter was cut from the wafer, and the cut circle was weighed in order to obtain the area density (mg/cm²) of the sample. FT-IR spectra collected from wafers of different density were normalized where noted, in order to make direct comparison of absorbance values from different samples valid.

### Adsorption Tests

CO₂ adsorption measurements under dry conditions were performed using a TA Q500 thermogravimetric analyzer using 10% CO₂ or 400 ppm CO₂ (balanced with argon). First, approximately 25 mg of the adsorbent was loaded into a platinum pan and subjected to pretreatment under an Ar flow (100 mL/min) at 110° C. for 180 min with a ramping rate of 5° C./min. Then the temperature was lowered to 25° C. and held for 60 min to stabilize the sample weight and temperature before introducing the CO₂-containing gas. Adsorption experiments were started by exposing the samples to dry CO₂ (10% or 400 ppm CO₂ in Ar) at a flow rate of 100 mL/min for 12 h, during which the weight gains were monitored. In the regenerability tests of the adsorbent, the desorption/adsorption cycles were repeated four times to trace the changes of the adsorption capacities.

### Heteroatoms Are Metal Species

### I

Materials

Pluronic P123 block copolymer (PEO₂₀-PPO₇₀-PEO₂₀, M_{w}=5,800), tetraethylorthosilicate (Si(OEt)₄, purity 98%), tetramethylorthosilicate (Si(OMe)₄, purity 98%), titanium tetraisopropoxide (Ti(OⁱPr)₄, purity >99%), zirconium(IV) oxychloride octahydrate (ZrOCl₂.8H₂O, purity >99%), aluminium isopropoxide (Al(OⁱPr)₃, purity >99%), cerium(III) nitrate hexahydrate (Ce(NO₃)₃.6H₂O, purity >99.9%), ammonium fluoride (NH₄F, purity 98%), methanol (reagent grade) and low-molecular weight poly(ethyleneimine) (PEI, M_{w}≈800 Da) were purchased from Sigma-Aldrich. All other chemicals used for material synthesis were also purchased from Sigma-Aldrich and used without further purification. Single-component gases were purchased from Airgas, Inc. Custom gas mixtures (10% and 400 ppm CO₂ in Ar) were purchased from Matheson Tri-Gas, Inc.

Synthesis

Al-SBA-15 Synthesis: Al-SBA-15 supports were synthesized similar to previously reported methods with minor modifications. In a typical synthesis, 4.0 g of Pluronic P123 as a pore directing agent and 100 g of 0.2 N HCl aqueous solution were stirred for 2 h in a 300 mL flask. To this micellular solution, an amount of aluminium isopropoxide as an aluminium source and 9.0 g of tetraethylorthosilicate (TEOS) as a silicon source were sequentially added and stirred at 40° C. for 1 day. The molar ratio of the initial gel was adjusted to P123:Si:Al:HCl:H₂O=0.016:1.0:(0-0.25):0.468:130. The solution was transferred to an oven and then hydrothermally reacted at 100° C. for another 2 days under static conditions. The resulting product was filtered, washed with deionized water, and dried overnight at 75° C. The as-synthesized Al-SBA-15 samples were finally calcined in air at 500° C. for 10 h at a ramping rate of 3° C./min to remove the organic template. The synthesized samples were named as Al_{X}-SBA-15, where X is the atomic ratio of Al/Si in the final solid.

Ti-SBA-15 Synthesis: Ti-SBA-15 supports were synthesized similar to previously reported methods with minor modifications. In a typical synthesis, 2.67 g of Pluronic P123 as a pore directing agent, 35.1 mg of NH₄F, and 100 g of 0.1N HCl aqueous solution were stirred for 2 h in a 300 mL flask. To this micellular solution, a mixed solution containing an amount of titanium tetraisopropoxide (TPOT) as a titanium source and 4.7 g of tetramethylorthosilicate (TMOS) as a silicon source was added and stirred at 40° C. for 1 day. The molar ratio of the initial gel was adjusted to P123:Si:Ti:NH₄F:H₂O=0.015:1.0:(0-0.1):0.03:180. The solution was then hydrothermally reacted at 80° C. for another 2 days under static conditions. The resulting product was filtered, washed with deionized water, and dried overnight at 75° C. The as-synthesized Ti-SBA-15 samples were finally calcined in air at 500° C. for 10 h at a ramping rate of 3° C./min to remove the organic template. The synthesized samples were named as Ti_{X}-SBA-15, where X is the atomic ratio of Ti/Si in the final solid.

Zr-SBA-15 Synthesis: Zr-SBA-15 supports were synthesized similar to previously reported methods with minor modifications. In a typical synthesis, 3.0 g of Pluronic P123 as a pore directing agent, 1.77 g of NaCl, and 120 g of H₂O were stirred for 2 h in a 300 mL flask. To this micellular solution, an amount of zirconium oxychloride octahydrate as a zirconium source and 6.44 g of tetraethylorthosilicate (TEOS) as a silicon source were sequentially added and stirred at 40° C. for 1 day. The molar ratio of the initial gel was adjusted to P123:Si:Zr:NaCl:H₂O=0.017:1.0:(0-0.2):1.0:220. The solution was transferred to an oven and then hydrothermally reacted at 100° C. for another day under static conditions. The resulting product was filtered, washed with deionized water, and dried overnight at 75° C. The as-synthesized Zr-SBA-15 samples were finally calcined in air at 500° C. for 10 h at a ramping rate of 3° C./min to remove the organic template. The synthesized samples were named as Zr_{X}-SBA-15, where X is the atomic ratio of Zr/Si in the final solid.

Ce-SBA-15 Synthesis: Ce-SBA-15 supports were synthesized according to previously reported methods with minor modifications. In a typical synthesis, 2.67 g of Pluronic P123 as a pore directing agent, 35.1 mg of NH₄F, and 100 g of 0.1N HCl aqueous solution were stirred for 2 h in a 300 mL flask. To this micellular solution, an amount of cerium(III) nitrate hexahydrate as a cerium source and 6.44 g of tetraethylorthosilicate (TEOS) as a silicon source were sequentially added and stirred at 40° C. for 1 day. The molar ratio of the initial gel was adjusted to P123:Si:Ce:NH₄F:H₂O=0.015:1.0:(0-0.1):0.03:180. The solution was transferred to an oven and then hydrothermally reacted at 100° C. for another 2 days under static conditions. The resulting product was filtered, washed with deionized water, and dried overnight at 75° C. The as-synthesized Ce-SBA-15 samples were finally calcined in air at 500° C. for 10 h at a ramping rate of 3° C./min to remove the organic template. The synthesized samples were named as Ce_{X}-SBA-15, where X is the atomic ratio of Ce/Si in the final solid.

### II

Synthesis of Materials

All chemicals used for material synthesis were purchased from Sigma-Aldrich and used without further purification. A variety of heteroatom-substituted SBA-15 supports, Me-SBA-15 (Me=Al, Ti, Zr, and Ce), with varied metal content were synthesized by sol-gel process using Pluronic P123 block copolymer (PEO₂₀-PPO₇₀-PEO₂₀, M_{w}=5,800) as a pore directing agent and tetraethyl orthosilicate (TEOS, 98%) as a silicon source under acidic conditions according to previous reports with minor modifications. Briefly, Pluronic P123 was dissolved in HCl aqueous solution with vigorous stirring for 2 h in a flask, in which a portion of NH₄F and NaCl was added as a catalyst for Ti-SBA-15 and Zr-SBA-15 syntheses, respectively, to facilitate heteroatom incorporation (no specific catalyst was added for Al- and Ce-SBA-15 syntheses). To this micellular solution, a designated amount of each metal source and TEOS were sequentially added and stirred at 40° C. for 1 day, in which titanium(IV) tetraisopropoxide (Ti(OⁱPr)₄, >99%), zirconium(IV) oxychloride octahydrate (ZrOCl₂.8H₂O, >99%), aluminum(III) isopropoxide (Al(OⁱPr)₃, >99%), and cerium(III) nitrate hexahydrate (Ce(NO₃)₃.6H₂O, >99.9%) were used as metal precursors. The solution was then transferred to a pressure bottle, sealed, and hydrothermally reacted at 100° C. for another 2 days under static conditions. The resulting product was filtered, washed with deionized water, and dried overnight at 75° C. The as-synthesized Me-SBA-15 samples were finally calcined in air at 500° C. for 10 h at a ramping rate of 3° C./min to remove the organic template. The calcined samples were denoted as Me_{X}-SBA-15 (Me=Al, Ti, Zr, and Ce), where X is the atomic ratio of Me/Si in the final solid. For detailed information on material synthesis, readers are referred to the supporting information.

Synthesis of PEI-Impregnated Adsorbents

A low-molecular weight, branched poly(ethyleneimine) (PEI, M_{W}≈800 Da) was used as the amine functionality, as this aminopolymer has high amine density and accessible primary amine sites on chain ends. The PEI-impregnated adsorbents were prepared by a conventional wet impregnation method. Specifically, the silica support previously dried at 75° C. overnight was immersed into a mixed solution containing the desired amounts of PEI and methanol (>99.8%, reagent grade), and then stirred at room temperature for 1 day. The weight ratios of this slurry were always maintained constant at PEI/methanol/silica=0.43:10.0:1.0. This slurry was then placed in a rotary evaporator, and the methanol was removed under vacuum to facilitate the incorporation of the aminopolymer into the silica support. The resultant solid product was collected and stored in an oven at 75° C. until further characterization. The silica supported amine composites thus synthesized were named PEI/Me_{X}-SBA-15 (Me=Al, Ti, Zr, and Ce).

Characterization

Powder XRD patterns were recorded on an M03X-HF (Bruker AXS) diffractometer with CuKα radiation (λ=1.54056 Å). Nitrogen adsorption-desorption isotherms were measured at −196° C. using Micromeritics TriStar II 3020. The calcined samples were degassed at 200° C. under vacuum for 12 h prior to the measurements, while the PEI-impregnated samples were degassed at 100° C. for at least 12 h to vaporize physisorbed water. The specific surface area was calculated by the BET (Brunauer-Emmett-Teller) method using adsorption data ranging from P/P₀=0.05 to 0.30. The pore size distributions were obtained from the adsorption branch of the nitrogen isotherms by the BdB-FHH (Frenkell-Halsey-Hill-modified Broekhoff-de Boer) method, which has been shown to be more accurate than the Barret-Joyner-Halenda method (BJH) for practical application to mesoporous materials. TEM images were obtained with a JEOL JEM100CX2 electron microscope. Elemental analysis was performed by Columbia Analytical Services. Amine loadings were determined by TGA using Netzsch STA409 instrument, in which the samples (ca. 20 mg) were subjected to continuous heating from room temperature to 800° C. under a mixed gas stream of air (30 mL/min) and nitrogen (30 mL/min) at a heating rate of 10° C./min using α-Al₂O₃ as a standard. FT-Raman spectra were obtained on a Bruker Vertex 80v optical bench with a RAMII Raman module in the spectral range of 200-1400/cm with the spatial resolution of 4/cm. Ti K-edge and Zr K-edge X-ray absorption fine structure (XAFS) spectra were recorded in fluorescence mode at room temperature at BL-7C facility of the Photon Factory at the National Laboratory for High-Energy Physics, Tsukuba, Japan and at BL01B1 facility of SPring-8, Hyogo, Japan, respectively. All extended XAFS (EXAFS) data were examined using an EXAFS analysis program, Rigaku EXAFS, whereby Fourier transformation of k³-weighted normalized EXAFS data (FT-EXAFS) was performed over the range 1.0<k/Å⁻¹<11.0 to obtain the radial structure function.

The acidity and basicity of the materials were studied by NH₃/CO₂-TPD using a Micromeritics AutoChem II 2920 Chemisorption Analyzer. Approximately 100 mg of each sample was preheated at 500° C. for 1 h under a He flow (10 mL/min), and subsequently was allowed to cool to 50° C., where it was exposed to flowing NH₃ (2000 ppm in N₂) or CO₂ (bone dry CO₂) with a flow rate of 30 mL/min for 1 h. Then, the system was purged at 50° C. for 30 min with He to remove weakly adsorbed NH₃ or CO₂ molecules. The NH₃/CO₂-TPD was carried out between 50 and 500° C. under a He flow (10 mL/min) with a ramping rate of 10° C./min, and the desorbed NH₃/CO₂ was quantified by a thermal conductivity detector.

FT-IR spectroscopy was performed by using a Thermo Scientific 8700 FT-IR instrument with a MCT/A detector. For in situ FT-IR spectroscopy of CO₂ adsorption/desorption, each sample was pressed into a self-supported wafer prior to analysis. The wafer was loaded into a high-vacuum transmission FT-IR cell and was heated to 105° C. under vacuum (less than 10⁻⁶ mbar) for a duration of at least 12 h, and the “activated” sample spectrum was collected after cooling to room temperature. FT-IR difference spectra of CO₂ adsorbed on the samples were obtained with increasing CO₂ pressures from 0 to 11 mbar by subtracting the “activated” sample spectrum from the CO₂ dosed spectrum. FT-IR difference spectra of CO₂ desorbed from CO₂-saturated samples were collected every 120 s during evacuation under high vacuum at room temperature for 1 h, and utilized the aforementioned spectral subtraction procedure. FT-IR spectra were normalized by the area densities of the wafers to make direct comparison of absorbance values from different samples valid.

Adsorption Tests

CO₂ adsorption measurements under dry conditions were performed using a TA Instruments Model Q500 thermogravimetric analyzer using 10% CO₂ or 400 ppm CO₂ balanced with Ar. First, approximately 25 mg of the adsorbent was loaded into a platinum pan and subjected to pretreatment under an Ar flow (100 mL/min) at 110° C. for 180 min with a ramping rate of 5° C./min. The temperature was then lowered to 25° C. and held for 60 min to stabilize the sample weight and temperature before introducing the CO₂-containing gas. Adsorption was initiated by exposing the samples to dry target gas of desired concentration (10% or 400 ppm CO₂ balanced with Ar) at a flow rate of 100 mL/min for 12 h, during which the weight gains were monitored. This adsorption time was sufficient to consider the amount of adsorbed CO₂ as a pseudo-equilibrium capacity. In the regenerability tests of the adsorbent, the desorption/adsorption cycles were repeated four times to trace the changes of the adsorption capacities.

### III

Characterizations of the Materials:

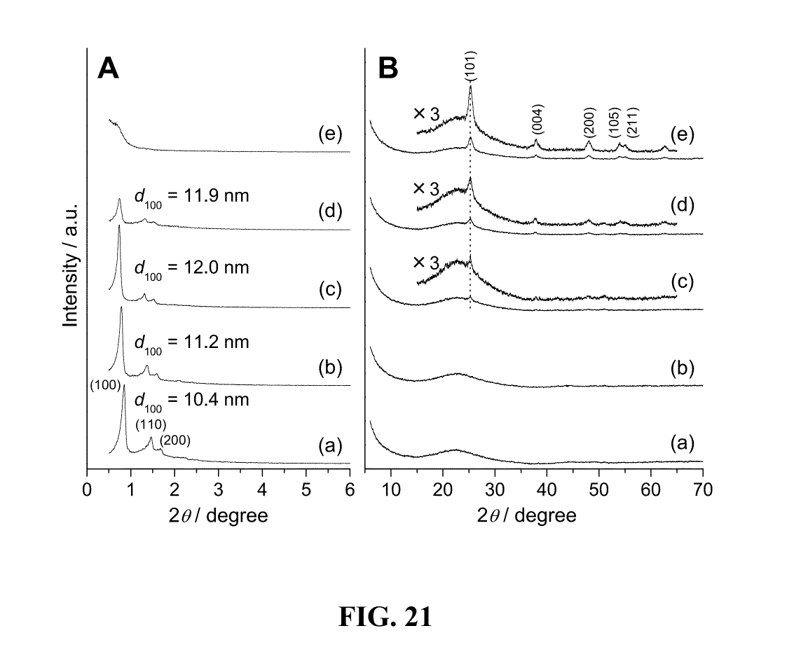

The structural characteristics of a series of heteroatom-substituted SBA-15 support materials with varied metal concentrations were verified by X-ray diffraction (XRD) measurement, N₂ physisorption, and Transmission electron microscopy (TEM). For example, FIG. 21 shows XRD patterns of the pure silica SBA-15 and Ti-SBA-15 with varied Ti content (0.2˜8.0 mol % per Si). Low angle diffraction patterns of Ti-SBA-15 with up to 4.3 mol % of Ti exhibit well-defined peaks at 2θ=0.7-0.8 and two small diffractions that are indexed as the (100), (110), and (200) reflections, respectively, verifying that these samples have the typical 2D hexagonal mesoporous structure (P6 mm). The latter two peaks became less clearly resolved with an increase of Ti/Si ratio and eventually disappeared when more than 8.0 mol % of Ti was incorporated.

In the N₂ adsorption-desorptipon isotherms, all of the samples, except for Ti_{8.0}-SBA-15, displayed type IV isotherms with clear capillary condensation at around P/P₀=0.8 along with a hysteresis loop (FIG. 20A), reflecting the presence of defined mesopore channels with narrow size distributions. The textural parameters obtained from N₂ adsorption isotherms are summarized in TABLE 2. It was found that pore diameter increased from 8.5 to 10.7 nm with an increase in the Ti/Si ratio from 0.00 to 0.043, agreeing well with the (100) peak shift towards lower angles, as observed in XRD. Along with this, the specific surface areas and pore volumes increased from 683 to 758 m²/g and 1.19 to 1.41 cm³/g, respectively. As an outlying case, Ti_{8.0}-SBA-15 showed a broad diffraction pattern in the low-angle region in XRD (FIG. 20A (e)) and an additional inflection at P/P₀>0.9 in the N₂ adsorption isotherm, which corresponds to secondary macropores (FIG. 20A (e)). Nonetheless, the material had a large surface area (771 m²/g) and pore volume (1.67 cm³/g) comparable to those of the other samples. These results suggest that 4.3 mol % of Ti is the approximate upper limit that can be incorporated within the silica matrix of SBA-15 under these synthetic conditions while retaining ordered mesoporosity, and at higher percentages of Ti (more than 8.0 mol %), the ordered structure of SBA-15 appeared to degrade. Such a trend coincides with the previously reported results for Zr-SBA-15 materials, in which incorporation of more than 11 mol % of Zr led to a collapse of mesostructure (textural parameters are shown in TABLE 2).

In high angle XRD patterns, several diffraction planes associated with anatase TiO₂ crystals were observed as the Ti/Si ratio increased above 0.014, evidencing the aggregation of Ti species. This is due to the different hydrolysis and polymerization rates of the titanium precursor and silicon precursor (tetraethyl orthosilicate; TEOS). Similar results have been reported in many publications, whereby the overall trend suggests that the addition of more than 2 mol % of Ti leads to creation of polymeric titanium oxide moieties. Such aggregated species could not be observed for the Zr-SBA-15 materials at all Zr loading levels, suggesting a different coordination geometry of the heteroatoms in this case.

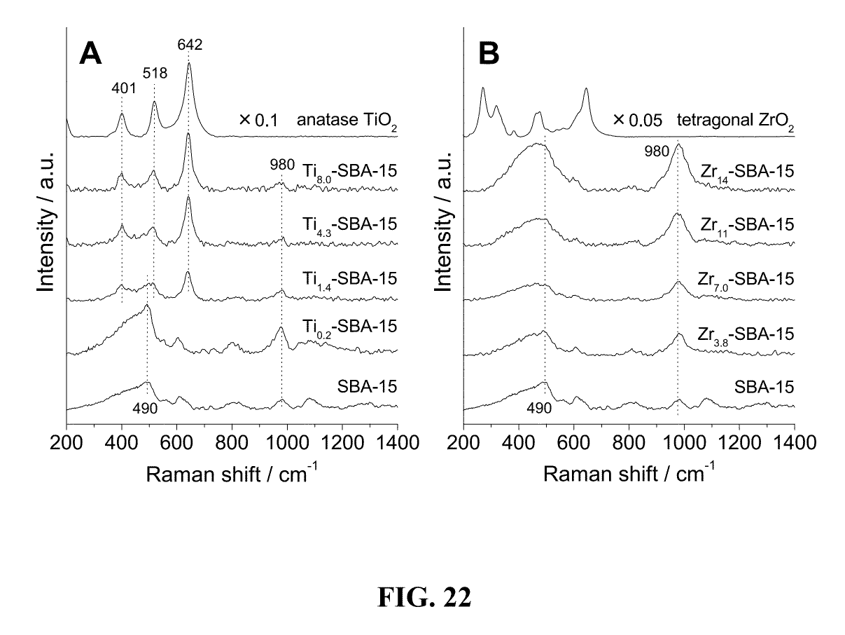

Investigation of the local structure of the Ti and Zr atoms in Ti-SBA-15 and Zr-SBA-15 materials was performed by the combination of FT-Raman spectroscopy and X-ray absorption fine structure (XAFS) analysis. FIG. 22A shows FT-Raman spectra of Ti-SBA-15 materials with different Ti content as well as that of anatase TiO₂, as a reference. The parent SBA-15 and Ti_{0.2}-SBA-15 exhibited several specific vibration modes at around 490 and 980/cm that are assigned to the asymmetric stretching vibration of the Si—O—Si bond and silica framework defects such as silanol groups, respectively. The defined peaks located around 401, 518, and 642/cm correspond to the B_{lg}, A_{lg}+B_{lg}, and E_{g} modes of anatase TiO₂, respectively, whose intensities were more pronounced upon increasing the Ti content. These results reveal that the Ti species are mostly present as highly dispersed species for Ti_{0.2}-SBA-15 but create agglomerated anatase TiO₂ species when more than 2 mol % of Ti was added in the initial gel. A collapse of the ordered structure, as observed in Ti_{8.0}-SBA-15, might be attributable to the formation of highly aggregated titanium oxide species within the silica matrix.

On the other hand, the Zr-SBA-15 samples exhibited no distinct peaks assignable to contiguous Zr—O—Zr bonds at all Zr levels as seen in FIG. 22B. They instead showed an FT-Raman shift of the band centered at 490/cm toward lower frequencies, along with increased intensities for the band centered at 980/cm, with increasing Zr content. These changes imply that Zr-insertion into the silica matrix simultaneously causes a distortion of the silica network and the creation of silica defect sites.

CO₂ Adsorption Performance:

The CO₂ adsorption performance of the PEI/Me-SBA-15 composites was evaluated by exposing the solids to a simulated flue gas (ca. 10% CO₂ balanced with Ar) or simulated ambient air (ca. 400 ppm CO₂ balanced with Ar) at a flow rate of 100 mL/min (both under dry conditions at 25° C.) using a thermal gravimetric apparatus (TGA). Here, a sufficiently long adsorption time (12 h) was chosen to render kinetic effects less significant and to evaluate the measured capacity as a function of the accessible adsorption sites. It is noteworthy that, in the absence of water, only primary and secondary amines are suggested to react with CO₂ to produce carbamates through the formation of zwitterionic intermediates. In this mechanism, an additional free base is required per mole of CO₂ captured for deprotonating the zwitterions to form the carbamates. Thereby, under dry conditions, the theoretical maximum amine efficiency, defined as the number of moles of CO₂ captured per mole of active amines, for the PEI-based adsorbent becomes 0.385, assuming an average amine ratio of PEI is primary:secondary:tertiary=44:33:23.

The measured CO₂ adsorption capacities are summarized in TABLE 2. These values closely approximate the pseudo-equilibrium CO₂ adsorption capacities calculated by fitting the adsorption curves with a pseudo-first-order adsorption model, thereby validating a direct comparison of these values. The measured CO₂ uptakes of the PEI/SBA-15 (one of the most well-studied class 1 supported amine adsorbents) as a standard sample were 0.19 and 0.65 mmol/g under identical 400 ppm and 10% CO₂ adsorption conditions, respectively, whose values seem slightly lower than those reported previously for similar materials. This is mainly because its lower PEI loading level, relatively lower concentrations of CO₂ gases, and use of dry adsorption conditions where two amine sites are required to capture one CO₂ molecule. Under both feed gas conditions (400 ppm CO₂ and 10% CO₂), the PEI aminopolymers supported on heteroatom-incorporated SBA-15 samples overall showed increased CO₂ adsorption performances. Depending on the metal species used and their concentrations in the support materials, the effective capacity varied, and the Zr-SBA-15 with Zr/Si ˜0.07 was found to be optimal for improving the CO₂ adsorption capacity, followed by Ce-SBA-15 and the series of Ti-SBA-15 materials.

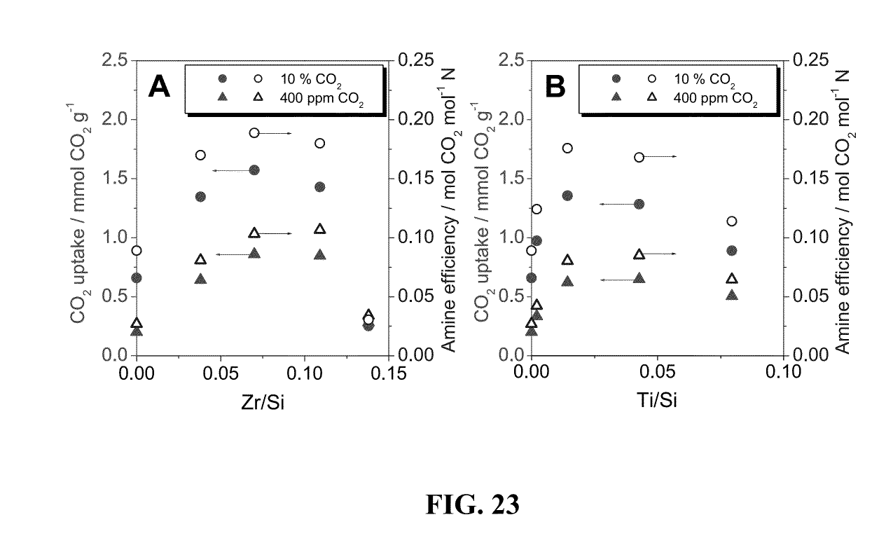

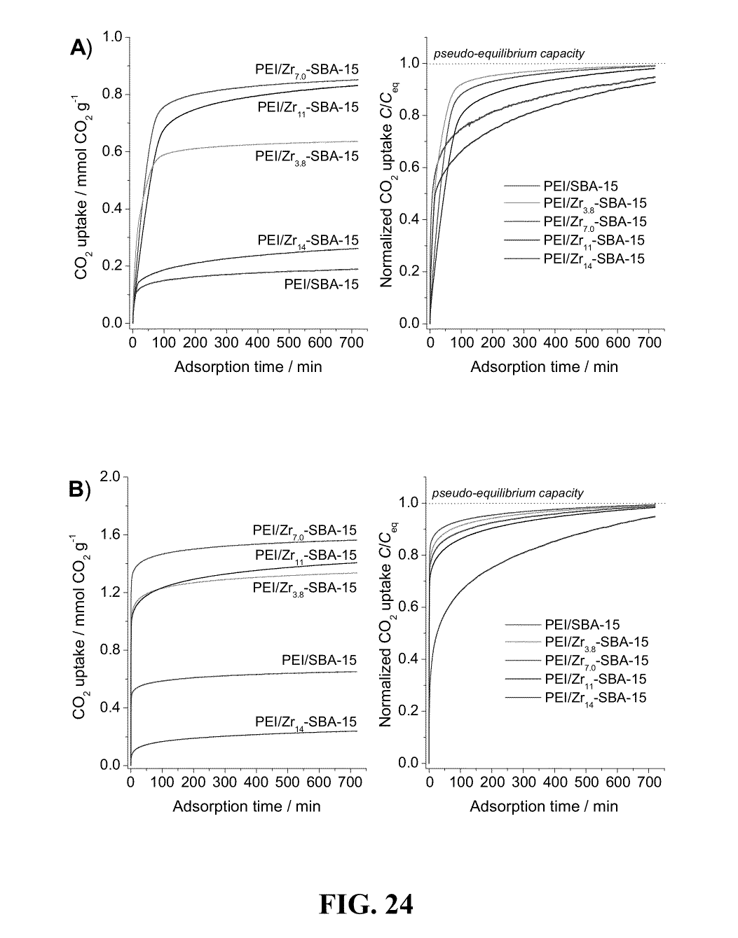

Comparisons of the pseudo-equilibrium CO₂ capture capacities and amine efficiencies over the series of PEI/Zr-SBA-15 composite adsorbents are shown in FIG. 23A. As noted above, incorporation of moderate levels of isolated Zr (Zr/Si=3.8˜11 mol %) within SBA-15 silica matrix afforded adsorbents with significantly increased CO₂ capacities and higher amine efficiencies, as well as faster adsorption rates (for CO₂ adsorption isotherms, see FIG. 24) compared to the prototypical PEI/SBA-15 adsorbent. As can be understood from Figure FIG. 23A, their CO₂ adsorption performances increased with increasing surface heteroatom coverage on silica at low metal loadings, whereas the use of Zr₁₄-SBA-15 as a support resulted in a substantial reduction in CO₂ uptake and amine efficiency. As the amine loading level were all similar, this decreased adsorption performance of the PEI/Zr₁₄-SBA-15 was attributed to low mass transfer or steric constraints induced by the poor structural characteristics of the support.

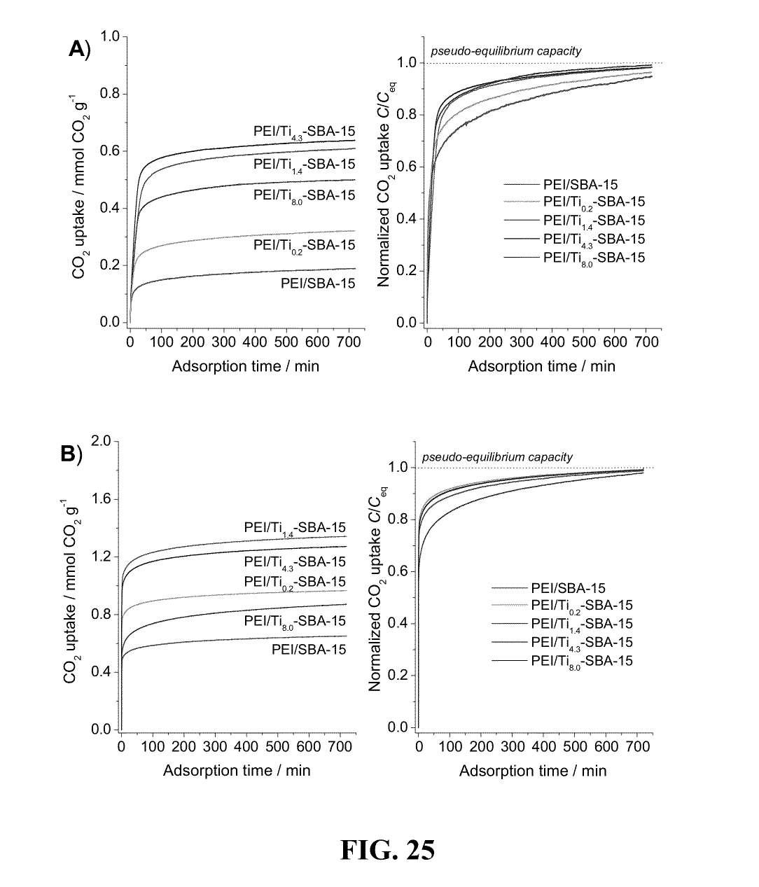

The adsorption data for the series of PEI/Ti-SBA-15 composite adsorbents also displayed a similar trend, albeit to a lesser degree (FIG. 23B). Under both 400 ppm and 10% CO₂ conditions, the series of PEI/Ti-SBA-15 composites all outperformed the conventional PEI/SBA-15 in terms of capacity, efficiency, and adsorption rate (for CO₂ adsorption isotherms, see FIG. 25), despite having approximately the same amine loading and structural parameters almost equal to those of the conventional PEI/SBA-15 material (see TABLE 2). Among these, the highest CO₂ uptake was attained for the PEI/Ti₄.3-SBA-15, which showed amine efficiencies 3.1 times and 1.9 times higher than the corresponding unmodified SBA-15 under identical 400 ppm and 10% CO₂ adsorption conditions, respectively, clearly demonstrating its promising CO₂ adsorption ability, especially from ultra-dilute gas. Similar to the Zr case above, the use of a poorly ordered silicate support, such as Ti_{8.0}-SBA-15, made the adsorbent less effective, indicating that a defined mesoporosity, in which the PEI polymer can be sequestered and uniformly dispersed, is helpful for achieving high CO₂ capacity in this type of composite adsorbent. Considering this, the aggregation states of Ti species does not seem to correlate with the CO₂ adsorption capacities, which are instead more correlated with the pore characteristics of the supports.

Cerium oxide nanocrystals dispersed in SBA-15 helped the composite adsorbent capture up to 3.6 times as much CO₂ in 400 ppm CO₂ conditions, demonstrating that Ce-SBA-15 can be a viable option as an efficient support material for PEI adsorbents, even though uniform incorporation of Ce into the SBA-15 framework was not achieved in this study (see FIG. 23). Considering the fact that the incorporated amounts of Ce atoms (Ce/Si=0.004-0.006) were much lower than the other metal-containing supports, it is inferred that the enhancement of CO₂ capacity cannot be solely attributed to the amount of heteroatoms incorporated, but should be associated with the overall nature of the supports (e.g., acid/base properties).

Al-substitution resulted in a material with only 1.5 times increased capacity for adsorbing CO₂ from the simulated ambient air. The effect of Al-incorporation into silica supports using similar class 1 composite adsorbents has been investigated comprising 50 wt % PEI-impregnated Al-MCM-41, whereby the Al content was ca. 0.2-1.0 mol %. They reported that 12% larger CO₂ adsorption capacity could be obtained by using the PEI supported on Al-MCM-41 compared with PEI/MCM-41 under the applied adsorption conditions (pure CO₂ gas flow and at 75° C.). However, they attributed this improved CO₂ uptake to the increased pore characteristics of the Al-MCM-41 supports (e.g., extended pore diameter and remaining pore volume). Compared to this, the PEI/Al-SBA-15 adsorbents examined in this study present a more marked difference in CO₂ uptake, despite showing almost similar pore characteristics as the standard PEI/SBA-15 (see TABLE 2). Another aspect that needs to be taken into account for Al-substituted silica materials is the surface acidity, which may play a negative role if combined with PEI, as will be discussed below.

Thus, by varying the heteroatom species, it has been observed that both isolated and aggregated heteroatoms can drastically alter the ability of PEI to adsorb CO₂. At optimal metal concentrations, the CO₂ capacity using 400 ppm CO₂ gases increases in the order of: PEI/SBA-15<PEI/Al-SBA-15<PEI/Ti-SBA-15<PEI/Ce-SBA-15<PEI/Zr-SBA-15.

Surface Properties of Supports:

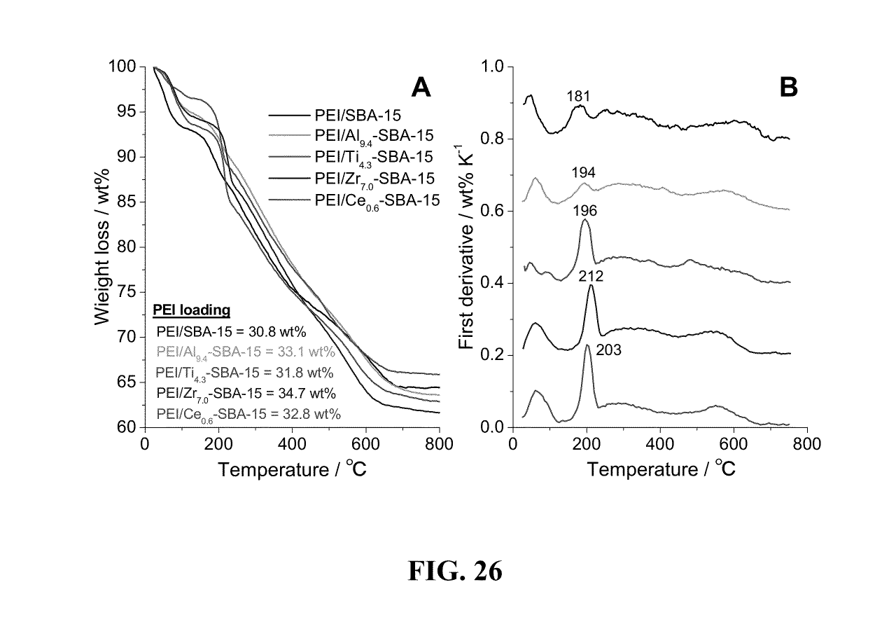

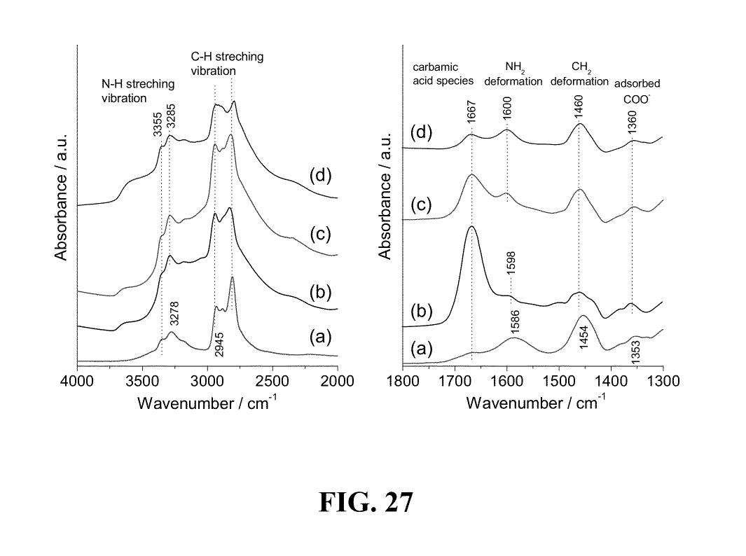

TGA and FT-IR analyses preliminarily provided some insight into the aminopolymer-surface interactions. FIGS. 26A and 26B display TGA weight loss curves and their first derivatives for the series of materials comprised of PEI supported on various Me-SBA-15 solids. The first weight losses that occurred below 120° C. can be attributed to the removal of physisorbed volatile species such as moisture. The sharp weight losses seen at the temperature of 120-220° C. can be associated with the partial oxidation of amino groups of PEI interacting with the silica surface, and the weight losses at higher temperature (220≦T≦700° C.) are assigned to the combustion of any residual organic PEI polymer, as well as condensation of silanol groups. The PEI supported on Ti-SBA-15 presented ca. 15° C. higher PEI oxidation temperatures compared to the traditional PEI/SBA-15 (cf. FIG. 26B), and this shift was more pronounced in the order of: PEI/SBA-15 (181° C.)<PEI/Al-SBA-15 (194° C.)<PEI/Ti-SBA-15 (196° C.)<PEI/Ce-SBA-15 (203° C.)<PEI/Zr-SBA-15 (212° C.), being perfectly consistent with the order of CO₂ adsorption capacity observed above. Such a suggestive shift was also observed in FT-IR spectra. A PEI impregnated onto the pure silica SBA-15 support exhibited several peak shifts assignable to NH₂ and CH₂ deformations of the PEI polymer, and specifically, the former peak shift was more pronounced when the PEI was impregnated onto the heteroatom-substituted SBA-15 samples, such as Ti_{4.3}-SBA-15 Zr_{7.0}-SBA-15 (see FIG. 27). These findings suggest that the PEI sequestered inside the pores, more specifically the amine groups of the PEI, interacts with the support surface in a different manner than with the pure silica SBA-15 surface and these interactions provide better thermal stability compared to the conventional PEI/SBA-15 adsorbent.

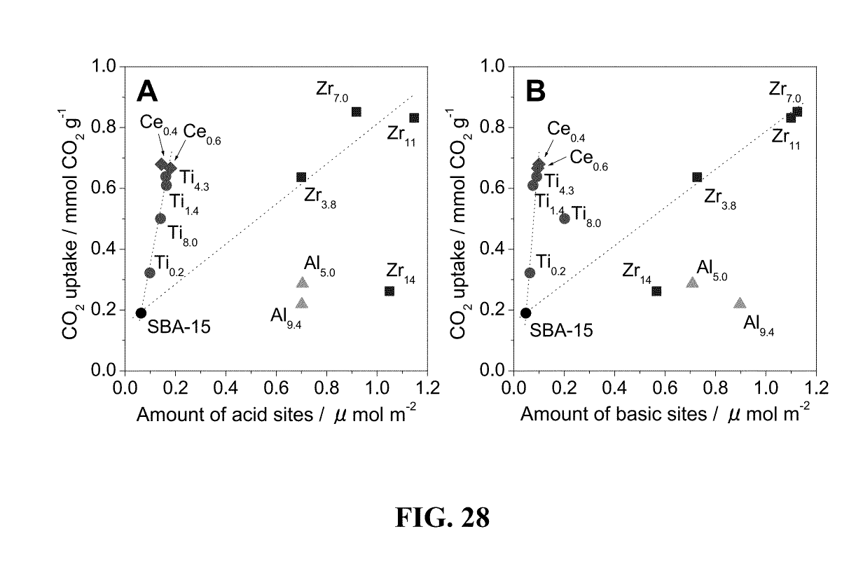

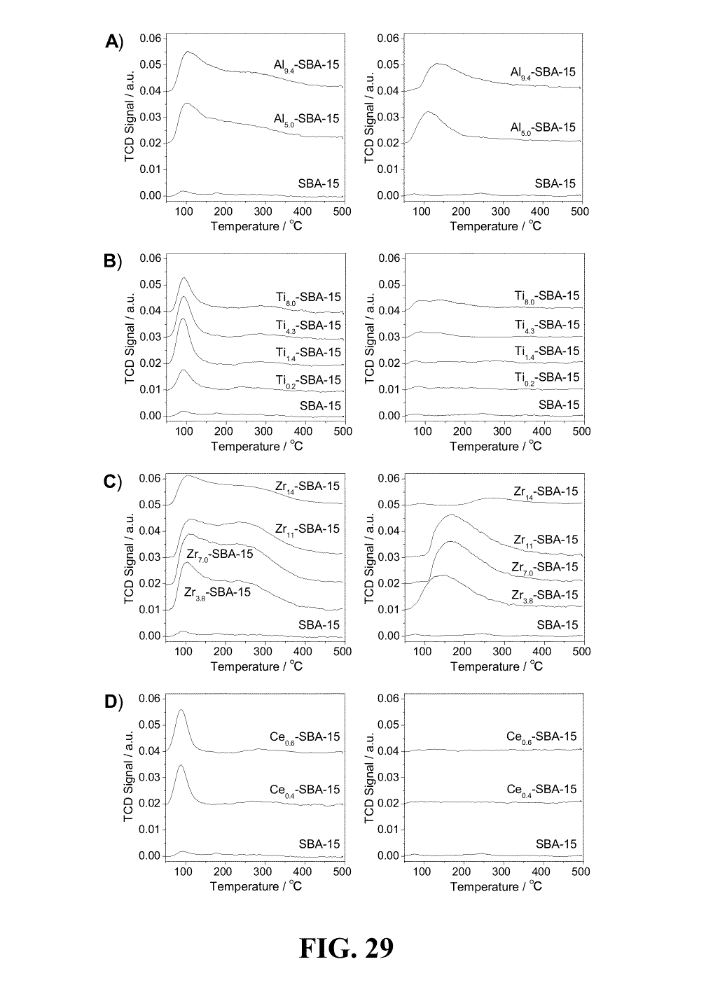

To further elucidate this intricate aminopolymer-surface interaction, a quantitative study was performed by plotting the measured CO₂ adsorption capacities of the PEI/Me-SBA-15 materials as a function of the surface density of the acid/base centres of the supports (FIG. 28), which were determined by NH₃/CO₂ TPD analysis, respectively (for TPD profiles, see FIG. 29). Both the surface acid and base densities generally increased in a roughly linear fashion with increasing surface heteroatom coverage on silica, and several distinguishable correlations between the measured CO₂ capacities and the surface acid/base densities were observed. For instance, Zr substitution into silica matrix, which is known to predominantly create Lewis acid sites (but also gives rise to trace of weak Brønsted acid sites associated with silica defect sites), created more acid/base sites on the silica surface compared to use of other heteroatoms.

A deviation from the correlation by Zr₁₄-SBA-15 is due to its subpar porosity characteristics, as mentioned above. Although the Al-SBA-15 materials possessed acid/base bifunctionality similar to the Zr-SBA-15 materials, the CO₂ adsorption capacities of the resultant composite adsorbents were significantly lower. This might be due to the presence of strong Brønsted acidity associated with Al-substitution. Unlike the case of substitution by tetravalent cations such as Zr⁴⁺ and Ti⁴⁺, substituting silicon by trivalent cations such as Al³⁺ in the mesoporous silica wall provides Brønsted acid sites on the surface by compensating the negative framework charge with protons. Such surface Brønsted acidic sites do not seem to effectively function as productive sites for the aminopolymer. In comparison, Ti- and Ce-incorporated SBA-15 materials, both of which afford a mildly acidic surface by creating weak Lewis acid sites (basic sites are scarcely observed), effectively contributed to enhanced CO₂ capture properties, despite their lower surface acid densities than the Al- or Zr-SBA-15 materials. It appears that the heteroatom incorporation reinforces the interaction between PEI and the silicate surface, thereby leading to the enhanced CO₂ adsorption capacity when compared to unsubstituted SBA-15. A plausible explanation for this interaction arises via an acid-base interaction between primary amines, present on all chain ends in PEI, and the heteroatom-associated Lewis acid sites on the silicate surface, which may stabilize and/or change the structure of PEI and potentially enhance the accessibility of the rest of the amines to incoming CO₂, whereas interactions between amines and a strong Brønsted acid sites created by Al-substitution may be unproductive for this purpose.

CO₂ Adsorption Kinetics:

The kinetics of adsorption and desorption are also important in assessing an adsorbent's performance, since practical CO₂ capture applications require short adsorption/desorption cycle times to reduce the total quantity of adsorbent in an installation.

The incorporation of heteroatoms into the silica matrix of the class 1 adsorbents made a significant impact on the adsorption kinetics as well. As mentioned above, the series of PEI/Zr-SBA-15 and PEI/Ti-SBA-15 samples exhibited faster CO₂ adsorption kinetics, which were more obvious at the 400 ppm CO₂ adsorption conditions than at the 10% CO₂ conditions. At 400 ppm CO₂, the adsorption curves of the series of PEI/Zr-SBA-15 and PEI/Ti-SBA-15 samples showed steep increases (exceeded 80% of the pseudo-equilibrium capacities within the first 90 min of adsorption), followed by much faster rates of saturation for the adsorption-equilibrium compared to the conventional PEI/SBA-15 (see FIGS. 24, 25), indicative of efficient access of the ultra-dilute CO₂ gas into the amine adsorption sites for the PEI/Zr-SBA-15 and PEI/Ti-SBA-15 adsorbents and conversely a diffusional restriction of CO₂ into the PEI/SBA-15 adsorbent. The PEI/SBA-15 material unexpectedly showed the fastest initial adsorption rate at the very initial stage of adsorption (adsorption time <30 min) but required a longer time to reach adsorption equilibrium under 400 ppm CO₂ (see FIG. 25A). This is most likely because of the limited number of amine adsorption sites available and the limited accessibility of ultra-dilute CO₂ into the interior amine sites, perhaps caused by the relative aggregation of PEI in this sample (will be discussed later).

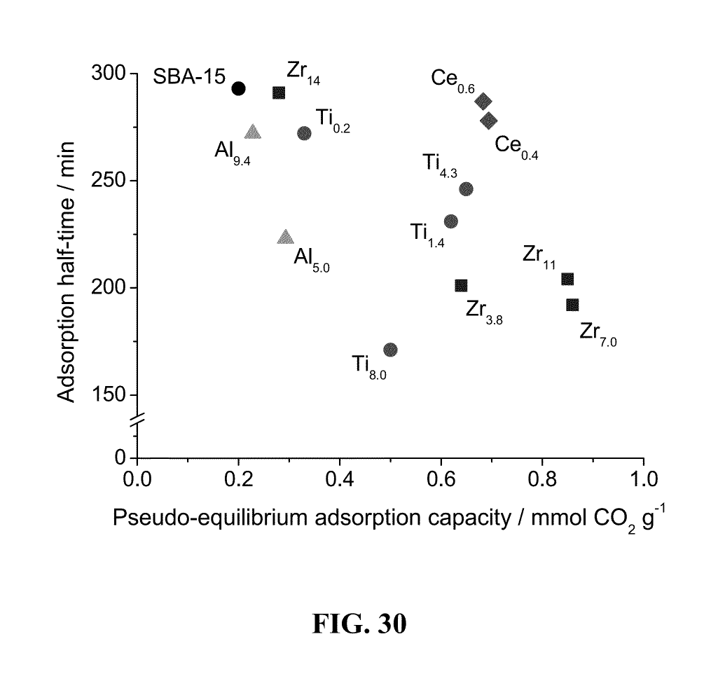

More importantly, there was a strong link between the CO₂ adsorption capacities and the adsorption rates. FIG. 30 illustrates a correlation between the pseudo-equilibrium CO₂ adsorption capacity (the values are shown in TABLE 2) and adsorption half-time under 400 ppm CO₂ adsorption conditions at an operating temperature of 25° C., both of which were calculated by fitting the CO₂ adsorption curves with a pseudo-first-order adsorption model. Here, the adsorption half-time, which is kinetically the time to reach half of the pseudo-equilibrium adsorption capacity, was interpreted as an indication of adsorption rates of the adsorbents. Adsorbents located close to the bottom right of the plot can be regarded as more favorable adsorbents for real adsorption applications, combining both high working capacities and fast adsorption kinetics. Given that the plots for PEI/Ti_{8.0}-SBA-15 and PEI/Zr₁₄-SBA-15 are deviations due to their subpar pore characteristics as mentioned above, a fairly inverse correlation is observed in FIG. 30, i.e., the larger the CO₂ adsorption capacity, the faster the adsorption rate.

Among those, PEI/Zr-SBA-15 samples with Zr content of 7.0˜11, showing significantly increased adsorption capacities and shorter adsorption times, were found to be the most promising adsorbents for ultra-dilute CO₂ capture applications, followed by PEI/Ti-SBA-15 adsorbents with Ti content of 1.4˜4.3. It has been well-established that the adsorbent with higher amine loadings generally require longer times to approach adsorption equilibrium, however, the amine loadings are all similar for the materials described here. The adsorption kinetics of supported amine adsorbents are influenced by other factors, such as CO₂ diffusion into and out of the pores, CO₂ accessibility to the active amine sites, and the type and intrinsic chemical reaction rate of the amines. Considering that all these materials have similar porosity, similar amine types and loadings, and the measurement variables are all similar, the improved CO₂ adsorption kinetics observed in the PEI/Me-SBA-15 adsorbents are likely associated with differences in the accessibility of amines available, rather than with intrinsic chemical reaction rates.

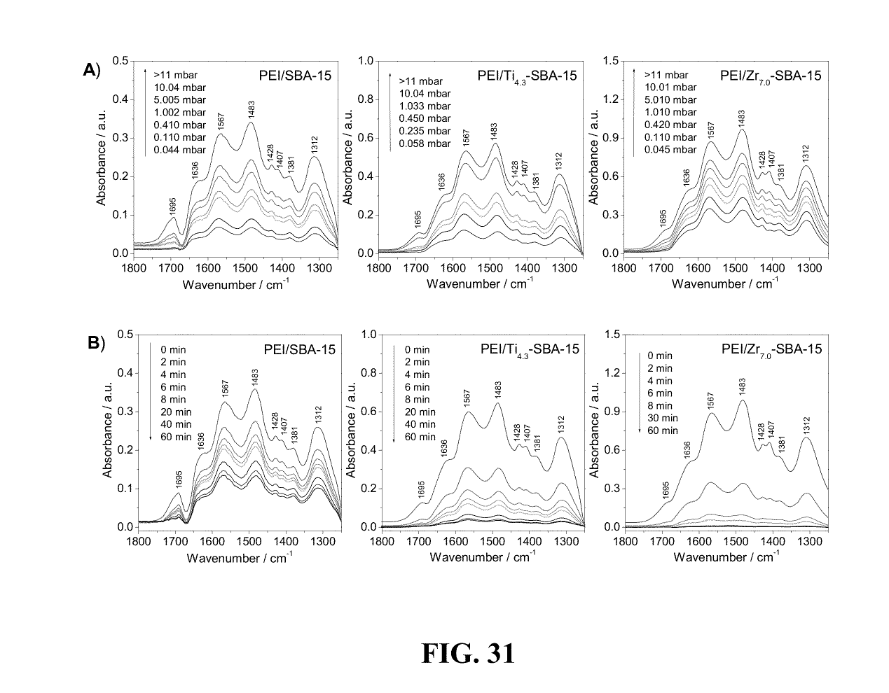

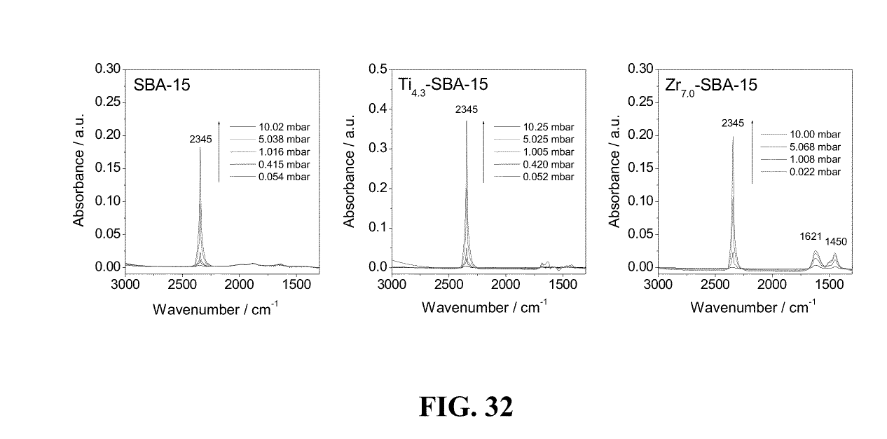

To provide molecular level insight into CO₂ adsorption on the materials, in situ FT-IR experiments were carried out using CO₂ as the probe molecule. FIG. 31A shows in situ FT-IR difference spectra of CO₂ adsorbed on PEI/SBA-15, PEI/Ti₄.3-SBA-15, and PEI/Zr_{7.0}-SBA-15 as representative adsorbents, with increasing CO₂ pressures. The observed absorption bands are all typical of those previously reported on conventional amine-based adsorbents, and no notable changes in IR peak positions during the experiments were observed, indicating that CO₂ is predominantly captured on primary and secondary amine sites in the PEI, forming ammonium carbamate and carbamic acid species. The negative peak seen at around 1670/cm in PEI/SBA-15 may attributable to the loss of adsorption sites, which may originate from remaining carbamic acid species strongly chemisorbed on aggregated PEI (see FIG. 27). At all CO₂ pressures, the PEI/Ti_{4.3}-SBA-15 and PEI/Zr_{7.0}-SBA-15 allowed for adsorption of several times more CO₂ compared with the conventional PEI/SBA-15, again verifying the presence of larger amount of accessible amine adsorption sites in these materials. Although one might hypothesize that the enhanced CO₂ adsorption performance was associated with the basic properties of the support surface, which could directly trap the entering CO₂ molecules, it was observed that the amount of CO₂ directly adsorbed on the bare Ti_{4.3}-SBA-15 and Zr_{7.0}-SBA-15 supports was minimal (they account for only 1% of the total CO₂ capacity of PEI-impregnated samples (see FIG. 32)). These observations discount the possibility of direct interaction between CO₂ and surface heteroatom-related basic sites driving the enhanced adsorption, and instead, productive surface-amine interactions are proposed.

More intriguing findings regarding the kinetics were obtained from in situ FT-IR difference spectra upon CO₂ desorption (FIG. 31B). The conventional adsorbent, PEI/SBA-15, shows a limited reversible CO₂ adsorption/desorption property under vacuum swing desorption conditions (less than 10⁻⁶ mbar and at room temperature), which is likely associated with an aggregation/degradation of the PEI during the CO₂ adsorption. In comparison, the PEI/Ti_{4.3}-SBA-15 allowed for more efficient CO₂ desorption within 60 min of applied vacuum, demonstrating a better CO₂ stripping ability than the traditional PEI/SBA-15. More significantly, the most rapid, nearly complete CO₂ desorption was observed on the PEI/Zr_{7.0}-SBA-15 adsorbent under the same desorption conditions, showing its excellent regenerability as an adsorbent. In an actual operation, the captured CO₂ must be isolated from the emission sources (or ambient air) and subsequently purified into a concentrated CO₂ stream. The ease of desorption of the captured CO₂ from the adsorbent demonstrated here, could contribute to improved economics in both conventional temperature swing and vacuum swing desorption processes for adsorbent regeneration. However, further system-level studies would be needed to fully substantiate this notion.

All the above experimental results led us to a generic conclusion that heteroatoms incorporated into silica create an amphoteric surface that is responsible for stabilizing and/or changing the structure of PEI, limiting undesired degradation/aggregation of PEI via surface chemical interactions (possibly via acid-base interactions). Such a stabilized PEI is believed to have an increased number of productive amine adsorption sites and allow for easy access of incoming CO₂ molecules to the amine sites, accordingly affording significantly increased CO₂ adsorption capacities and improved CO₂ adsorption/desorption kinetics. It is conceivable that the configuration of the PEI aminopolymer substantially influences the adsorption chemistry. The understanding about distribution and physical structure of the aminopolymer within composite adsorbents is still poorly developed, and additional studies focused on this aspect are clearly needed.

Regenerability Test:

Beside the adsorption capacities and adsorption rates, stability of the CO₂ adsorbents is of key importance for practical CO₂ capture applications as well, because the lifetime of the adsorbents strongly affects the cost of the overall process. To examine the regenerability of the adsorbents, several selected composite adsorbents were subjected to multiple CO₂ adsorption/desorption cycles at 25° C. using 400 ppm CO₂/Ar flow, in which the CO₂ was desorbed from the surface in pure Ar atmosphere at 110° C. for 3 h.

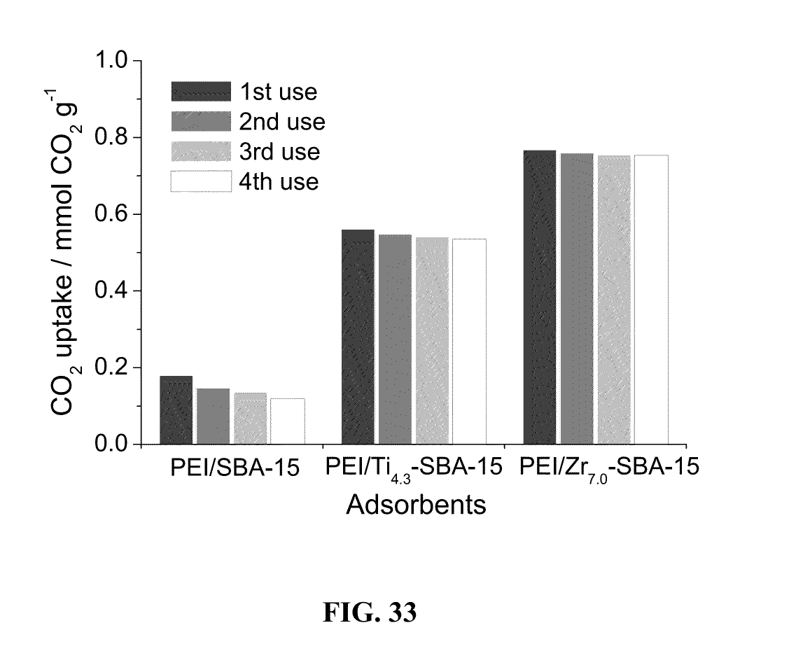

FIG. 33 compares CO₂ adsorption capacities of the conventional PEI/SBA-15, PEI/Ti_{4.3}-SBA-15, and PEI/Zr_{7.0}-SBA-15 composites over four adsorption/desorption cycles at 25° C. using ultra-dilute gas (400 ppm CO₂ in Ar). As clearly seen in FIG. 33, the conventional PEI/SBA-15 adsorbent showed a significant, continual capacity reduction in a temperature swing process during moderate cycling and eventually lost 34% of its CO₂ adsorption capacity after four cycles. Such a limited regenerability can be associated with the loss of CO₂ adsorption sites caused by thermal aggregation of the PEI, by amine degradation originating from urea formation, or by substantial amine loss during its repeated use. On the other hand, the PEI/Ti_{4.3}-SBA-15 and PEI/Zr₇.0-SBA-15 composites demonstrated improved regenerabilities over short, multicycle operation; the former adsorbent retained 95% of its capacity, whereas the PEI/Zr_{7.0}-SBA-15 retained more than 98% of its ability to reversibly adsorb CO₂ during the same number of cycles even under dry conditions. This improved regenerability is the consequence of the combination of the improved CO₂ desorption kinetics as demonstrated in the previous section, and the productive interactions between the PEI aminopolymer and the support surface, thereby limiting undesired aggregation/degradation of PEI, and accordingly providing thermal stability and adsorbent durability.

CO₂ Adsorption Under Humid Conditions:

Practical applications in CO₂ capture from both ambient air and mixed gas including moisture requires robust materials that are stable even in humid conditions. It has been recognized that the stability of most silica-based materials is too limited for practical application in the presence of steam, hence hybrid materials based on oxide supports that are more steam stable, such as alumina and titania, are needed. It should be noted that Sayari and co-workers reported no adverse effects of the presence of moderate amounts of water vapor on the chemical stability of silica-supported amine groups during the adsorption/desorption cycles in their studies.

TABLE 3
CO₂ Adsorption Capacities Of PEI/Zr_{7.0}-SBA-15 Under
Dry And Humid Conditions

| | CO₂ adsorbed | | CO₂ adsorbed |
|---|---|---|---|
| | under dry conditions^{[a]} | | under humid condition^{[b]} |
| | [mmol/g] | | [mmol/g] |
| Cycle | 400 ppm | 10% | 10% |
| 1st | 0.85 (0.110) | 1.56 (0.188) | 1.68 (0.202) |
| 2nd | 0.84 (0.109) | 1.54 (0.185) | 1.60 (0.192) |

The values in parentheses are the amine efficiencies.
^{[a]}Measured at 25° C. under dry conditions (adsorption time was fixed at 12 h).
^{[b]}Measured at 25° C. under humid conditions (adsorption time was fixed at 12 h).

To address the impact of water on the material structure and the ability of the amines to capture CO₂, an additional CO₂ adsorption experiment was carried out by contacting the PEI/Zr_{7.0}-SBA-15 sample, the most efficient adsorbent among those examined here, with a water-saturated 10% CO₂/Ar flow of 100 mL/min for 12 h using a fixed-bed reactor equipped with an on-line mass spectrometer. As summarized in TABLE 3, under humid conditions at 25° C., the CO₂ uptake increased 8% relative to the dry conditions and was fairly stable over two runs (1.68 mmol/g (cycle 1)→1.60 mmol/g (cycle 2)), showing only a modest enhancement of capacity under humid conditions. One might speculate that this unexpected low enhancement in the presence of humidity is the consequence of an alternate adsorption mechanism under dry conditions using the heteroatom-incorporated materials, i.e., the possibility that the surface-exposed heteroatoms function as sites to form carbamate-surface ion pairs, thus precluding the need for utilizing two amines to capture one CO₂ molecule and accordingly increasing amine efficiency even under dry conditions. However, the calculated amount of Zr per gram of the adsorbent (ca. 0.76 mmol/g) is lower than the amine content (8.33 mmol/g) by an order of magnitude, thereby discounting this possibility.

As previously mentioned, under humid conditions where water molecules can act as an additional base, the maximum amine efficiency could theoretically increase up to 2-fold. However, the enhancements are usually less than this theoretical maximum. The promoting effect of moisture for CO₂ capacity is known using 50 wt % PEI-impregnated MCM-41 adsorbent, where up to ca. 1.5 times larger CO₂ capacity was observed under a flow of mixed gas containing CO₂ and ˜16% moisture and at 75° C. Meanwhile, Sayari et al. have reported only a slight enhancement of CO₂ capacity using a similar material under a flow of water-saturated CO₂ and at 20° C. Goeppert et al. also found that 1.5 times increased CO₂ capacity could be achieved over 33 wt % PEI-impregnated fumed silica at 25° C. under 400 ppm CO₂ with 67% of relative humidity; however an adverse effect was observed for the adsorbent with a higher PEI loading (50 wt % PEI) where the adsorption is more diffusion-controlled, in which water molecules are considered to inhibit the access of incoming CO₂ to reach amine adsorption sites. As seen in these reports, CO₂ capacity in humid conditions can be strongly affected by several structural and operational factors, e.g, location/loading of amines within pores, pore blockage, steric hindrance from neighboring species, or concentration of moisture introduced, and these effects are more pronounced especially after long adsorption times where equilibrium is nearly reached and almost every accessible amine has captured a CO₂ molecule. A plausible explanation for the only modest enhancement under humid conditions in this case is due to steric hindrance from adsorbed water molecules, which might inhibit the access of the entering CO₂ to reach amine sites, although admittedly, further detailed studies are necessary to draw a more rational conclusion for this result.

Additionally, structural analyses of the used sample confirmed the crystallographic retention and structural stability of the material upon CO₂ adsorption under humid conditions (i.e., 25° C. for 12 h under a flow of water-saturated 10% CO₂ gas), in which phase-separation and porosity reduction of the zirconosilicate support originating from hydrolysis was negligible. Regarding the hydrothermal stability of zirconosilicate, a number of publications have commonly reported that they are highly stable against hydrothermal treatment (even in boiling water or in 100% steaming). These facts indicate that the PEI/Zr-SBA-15 and related materials can be potentially used under such humid conditions, and as such, these materials warrant further study under a variety of humid conditions.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. In a sorbent for CO₂ capture having an amine efficiency of X mol CO₂ mol⁻¹N, defined as the number of moles of CO₂ captured per mole of active amines, an improved sorbent comprising doping the sorbent with heteroatoms such that the amine efficiency is at least 110% X.

2. The sorbent of claim 1, wherein the sorbent with heteroatoms has an amine efficiency of at least 210% X.

3. The sorbent of claim 1, wherein the sorbent with heteroatoms has an amine efficiency of at least 400% X.

4. The sorbent of claim 1, wherein the sorbent comprises a nanocomposite sorbent.

5. The sorbent of claim 1, wherein the sorbent comprises silica nanoparticles and poly(ethyleneimine) (PEI).

6. The sorbent of claim 1, wherein the heteroatoms are selected from the group consisting of atoms of Zr, Ti, Fe, Ce, Al, B, Ga, Co, Ca, P, and Ni.

7. A sorbent for species capture comprising:
a porous material comprising silica;
a polymer; and
heteroatoms;
wherein the polymer is impregnated in the porous material; and
wherein the heteroatom/Si molar ratio is greater than 0.002.

8. The sorbent of claim 1, wherein the polymer is an amine-containing polymer.

9. The sorbent of claim 1, wherein the porous material is a mesoporous material.

10. The sorbent of claim 1, wherein the heteroatoms are metal atoms.

11. A sorbent for species capture comprising:
a framework of silica nanoparticles;
an amine-containing polymer; and
heteroatoms;
wherein the sorbent has a CO₂ adsorption of greater than 0.19 mmol CO₂/g when exposed to a 400 ppm CO₂/Ar flow at a rate of 100 mL/min.

12. The sorbent of claim 11, wherein the sorbent has a CO₂ adsorption of greater than 0.65 mmol CO₂/g when exposed to a 10% CO₂/Ar flow at a rate of 100 mL/min.

13. The sorbent of claim 11, wherein the heteroatom/Si molar ratio is greater than or equal to 0.002.

14. A sorbent for species capture comprising:
a framework of silica nanoparticles;
poly(ethyleneimine) (PEI); and
heteroatoms selected from the group consisting of atoms of Zr, Ti, Fe, Ce, Al, B, Ga, Co, Ca, P, and Ni.

15. The sorbent of claim 14, wherein the PEI is low molecular weight, branched PEI.

16. The sorbent of claim 14, wherein the framework is SBA-15.

17. A method of increasing species capture comprising doping silica supports with heteroatoms.

18. The method of claim 17, where in the species is CO₂.

19. The method of claim 17, where in the species is selected from the group consisting of H₂S, NO₂, SO₂, and NO.

20. The method of claim 17 further comprising capturing CO₂ with the doped silica supports with heteroatoms from a stream containing CO₂ with concentrations ranging from 1 ppm to 25% by volume.

21. The method of claim 17, wherein the heteroatoms are metal atoms, and the silica supports comprise polymeric amines.

22. The method of claim 17, wherein the heteroatoms are selected from the group consisting of atoms of Zr, Ti, Fe, Ce, Al, B, Ga, Co, Ca, P, and Ni.

23. The method of claim 21, wherein the polymeric amines are selected from the group consisting of poly(ethylenimine), poly(propylenimine), poly(allylamine), poly(vinylamine), and tetraethylenepentamine.

24. A method of enhancing material stability during species adsorption/desorption cycles comprising doping silica supports with heteroatoms.

25. The method of claim 24, where in the species is CO₂.

26. The method of claim 24, where in the species is selected from the group consisting of H₂S, NO₂, SO₂, and NO.

27. The method of claim 24 further comprising capturing CO₂ with the doped silica supports with heteroatoms from a stream containing CO₂ with concentrations ranging from 1 ppm to 25% by volume.

28. The method of claim 24, wherein the heteroatoms are metal atoms, and the silica supports comprise polymeric amines.

29. The method of claim 24, wherein the heteroatoms are selected from the group consisting of atoms of Zr, Ti, Fe, Ce, Al, B, Ga, Co, Ca. P, and Ni.

30. The method of claim 28, wherein the polymeric amines are selected from the group consisting of poly(ethylenimine), poly(propylenimine), poly(allylamine), poly(vinylamine), and tetraethylenepentamine
